(19) United States
(12) Patent Application Publication
(10) Pub. No.: US 2019/0361436 A1
(43) Pub. Date: Nov. 28, 2019

(54) REMOTE MONITORING SYSTEM AND REMOTE MONITORING DEVICE

(71) Applicant: Panasonic Intellectual Property Management Co., Ltd., Osaka (JP)

(72) Inventors: IORI UEDA, Kanagawa (JP); MASAAKI HOSHIDA, Kanagawa (JP); TOMOHIRO IWAMA, Kanagawa (JP)

(21) Appl. No.: 16/531,987

(22) Filed: Aug. 5, 2019

Related U.S. Application Data
(63) Continuation of application No. PCT/JP2018/003942, filed on Feb. 6, 2018.

(30) Foreign Application Priority Data
Feb. 24, 2017 (JP) 2017-033166
Feb. 24, 2017 (JP) 2017-033167
Feb. 24, 2017 (JP) 2017-033168
Feb. 24, 2017 (JP) 2017-033169
Nov. 2, 2017 (JP) 2017-213101

(51) Int. Cl. G05D 1/00; G06K 9/00; G07C 5/00; B60W 10/20; B60W 30/08

(52) U.S. Cl. CPC G05D 1/0038; G05D 1/0022; G05D 1/0088; G06K 9/00791; G07C 5/008; B60W 2550/40; B60W 30/08; G05D 2201/0213; B60W 2720/10; B60W 2720/24; B60W 10/20

(57) ABSTRACT

A vehicle of a remote monitoring system includes an imaging circuit for shooting a surrounding in at least a traveling direction, and a wireless communication circuit for transmitting an image shot by the imaging circuit. A remote monitoring device includes a communication circuit, and an output circuit. When a communication delay from the vehicle to the remote monitoring device via the network is first delay time, the output circuit cuts out a first range from a first frame of the first image and outputs the first range as the second image. When the communication delay from the vehicle to the remote monitoring device via the network is second delay time longer than the first delay time, the output circuit cuts out a second range narrower than the first range from a second frame of the first image and outputs the second range as the second image.

### CROSS-REFERENCE TO RELATED APPLICATIONS

This application is a continuation of the PCT International Application No. PCT/JP2018/003942 filed on Feb. 6, 2018, which claims the benefit of foreign priority of Japanese patent application No. 2017-033166, No. 2017-033167, No. 2017-033168, No. 2017-033169 all filed on Feb. 24, 2017, and No. 2017-213101 filed on Nov. 2, 2017, the contents all of which are incorporated herein by reference.

### BACKGROUND

### 1. Technical Field

The present disclosure relates to a remote monitoring system for remote-controlling an autonomous vehicle, and a remote monitoring device.

### 2. Description of the Related Art

In recent years, development of autonomous vehicles has been accelerated. Development of self-driving vehicles that do not need a driver is also being advanced. Self-driving vehicles that are not equipped with steering or a brake are developed and expected to be used in service vehicles such as taxis, buses, and transport trucks.

However, the realization of fully self-driving, as defined as Level 5 by NHTSA (National Highway Traffic Safety Administration), is expected to take many years. It is considered that a remote control technology is used as a technology in the transitional period until the completion of a fully unmanned autonomous vehicle, or as a technology complementing a fully unmanned autonomous vehicle (see, for example, Japanese Patent Unexamined Publications No. 2013-115803, No. 2000-184469, and No. 2010-61346). For example, a method is considered in which, a monitor (monitoring person) in a remote control center may monitor a plurality of self-driving vehicles and transmit instructions to the self-driving vehicles as necessary.

### SUMMARY

The present disclosure provides a technology that contributes to safe and proper remote control.

A remote monitoring system according to one aspect of the present disclosure includes a vehicle, and a remote monitoring device. The vehicle includes an imaging circuit configured to shoot a surrounding in at least a traveling direction of the vehicle, and a wireless communication circuit configured to transmit an image shot by the imaging circuit. The remote monitoring device includes a communication circuit configured to receive a first image from the wireless communication circuit via a network; and an output circuit configured to output a second image. In the remote monitoring device, in a case where a communication delay from the vehicle to the remote monitoring device via the network is first delay time, the output circuit cuts out a first range from a first frame of the first image and outputs the first range as the second image. In the remote monitoring device, in a case where the communication delay from the vehicle to the remote monitoring device via the network is second delay time that is longer than the first delay time, the output circuit cuts out a second range that is narrower than the first range from a second frame of the first image and outputs the second range as the second image.

An arbitrary combination of the above configuration elements, and a conversion of expressions of the present disclosure among methods, devices, systems, computer programs, and the like, are also effective as an aspect of the present disclosure.

The present disclosure can achieve safe and proper remote control.

### BRIEF DESCRIPTION OF DRAWINGS

FIG. 1 is a diagram showing an entire configuration of a remote self-driving system according to a first exemplary embodiment of the present disclosure.

FIG. 2 is a diagram showing a configuration of an autonomous vehicle according to the first exemplary embodiment of the present disclosure.

FIG. 3 is a diagram showing a configuration of a remote control device according to the first exemplary embodiment of the present disclosure.

FIG. 4 is a flowchart showing a basic operation of the remote self-driving system according to the first exemplary embodiment of the present disclosure.

FIG. 5 is a flowchart showing a flow of processing of a method for adjusting transmission data amount according to operation example 1.

FIG. 6A is a view showing one example of a monitoring picture displayed on a display of the remote control device, according to operation example 1.

FIG. 6B is a view showing one example of a monitoring picture displayed on the display of the remote control device, according to operation example 1.

FIG. 7 is a flowchart showing a flow of processing of a method for adjusting transmission data amount according to operation example 2.

FIG. 8A is a view showing one example of a monitoring picture displayed on a display of a remote control device, according to operation example 2.

FIG. 8B is a view showing one example of a monitoring picture displayed on the display of the remote control device, according to operation example 2.

FIG. 9 is a flowchart showing a flow of processing of a communication system switching method according to operation example 3.

FIG. 10 is a flowchart showing a flow of processing of a communication system switching method according to operation example 4.

FIG. 11 is a flowchart showing an operation of a remote self-driving system equipped with a high-quality picture request function according to operation example 5.

FIG. 12 is a flowchart showing an operation of a remote self-driving system equipped with a designating function of a traveling route at a time of restarting driving according to operation example 6.

FIG. 13 is a view showing one example of a case where a traveling route is designated on a monitoring picture displayed on a display of a remote control device according to operation example 6.

FIG. 14 is a flowchart showing an operation of a remote self-driving system equipped with a function of designating a traveling route at the time of restarting driving according to operation example 7.

FIG. 15 is a view showing one example of a case where a traveling route is designated on a monitoring picture displayed on a display of a remote control device according to operation example 7.

FIG. 16 is a view showing one example of a case where a traveling route is designated on a monitoring picture displayed on a display of a remote control device according to a modified example of operation examples 6 and 7.

FIG. 17 is a flowchart showing a flow of processing of a displaying method of a monitoring picture including a risk range object according to operation example 8.

FIG. 18A is a view showing one example of a monitoring picture displayed on a display of a remote control device, according to operation example 8.

FIG. 18B is a view showing one example of a monitoring picture displayed on the display of the remote control device, according to operation example 8.

FIG. 19 is a flowchart showing a flow of processing of a displaying method of a monitoring picture including a risk range object according to operation example 9.

FIG. 20 is a flowchart showing a flow of processing of a displaying method of a monitoring picture in which a communication delay is visualized according to operation example 10.

FIG. 21 is a view showing one example of a monitoring picture displayed on a display of a remote control device, according to operation example 10.

FIG. 22 is a flowchart showing a flow of processing of a displaying method of a monitoring picture in which a communication delay is visualized according to operation example 11.

FIG. 23 is a view showing one example of a monitoring picture displayed on a display of a remote control device, according to operation example 11.

FIG. 24 is a diagram showing a configuration of an autonomous vehicle according to a second exemplary embodiment of the present disclosure.

FIG. 25 is a diagram showing a configuration of a remote control device according to the second exemplary embodiment of the present disclosure.

FIG. 26 is a flowchart showing a flow of a basic operation when the remote control device according to the second exemplary embodiment of the present disclosure displays an image received from an autonomous vehicle.

FIG. 27 is a flowchart showing a flow of a development processing when the remote control device according to the second exemplary embodiment of the present disclosure displays an image received from an autonomous vehicle.

FIG. 28 is a flowchart showing a basic operation of a remote self-driving system according to the second exemplary embodiment of the present disclosure.

FIG. 29A is a view showing one example of a cut-out range cut out when an autonomous vehicle travels straight.

FIG. 29B is a view showing one example of a cut-out range cut out when an autonomous vehicle travels straight.

FIG. 30A is a view showing one example of a cut-out range cut out when an autonomous vehicle travels on a curve.

FIG. 30B is a view showing one example of a cut-out range cut out when an autonomous vehicle travels on a curve.

FIG. 31 is a view showing a state of steered wheels when an autonomous vehicle travels straight.

FIG. 32 is a view showing a state of the steered wheels when an autonomous vehicle travels on a curve to right.

FIG. 33 is a view showing a state of the steered wheels when an autonomous vehicle travels on a curve to left.

FIG. 34 shows an example of a first relation between a frame picture of a first image captured by a visible light camera of an autonomous vehicle and a frame picture of a second image to be displayed on a display of the remote control device.

FIG. 35 shows an example of a second relation between a frame picture of a first image captured by a visible light camera of an autonomous vehicle and a frame picture of a second image to be displayed on a display of the remote control device.

FIG. 36 is a view showing one example of a frame picture to be displayed on a display of a remote control device.

FIG. 37 is a view showing one example of a frame picture captured by a visible light camera having a fish-eye lens.

FIG. 38 is a bird's eye view of an intersection where an autonomous vehicle is present.

FIG. 39 is a view showing a frame picture captured when the autonomous vehicle is positioned at a first point of FIG. 38.

FIG. 40 is a view showing a frame picture captured when the autonomous vehicle is positioned at a second point of FIG. 38.

FIG. 41 is a view showing a frame picture captured immediately after the autonomous vehicle turns left from the first point of FIG. 38.

FIG. 42 is a bird's eye view of an intersection where an autonomous vehicle exists, in which a risk range object is superimposed.

FIG. 43 is a view showing a frame picture for display, generated from a cut-out range in the frame picture captured by a visible light camera of the autonomous vehicle positioned on the second point.

### DETAILED DESCRIPTION OF PREFERRED EMBODIMENTS

### First Exemplary Embodiment

In an unmanned autonomous vehicle partially incorporating remote control, sensed data obtained by sensing a state of a vehicle or a surrounding situation need to be transmitted from the vehicle to a remote control center via a network. However, for example, continuous transmission of picture data with high picture quality from the vehicle to the remote control center would cause increment in communication cost. Furthermore, the larger the amount of data to be transmitted is, the larger the influence of the communication delay becomes.

The first exemplary embodiment of the present disclosure has been made under such circumstances. A first object of the first exemplary embodiment is to provide a technology for reducing an amount of data to be transmitted from an autonomous vehicle to a remote control device while safety is ensured.

When an autonomous vehicle senses dangerous events such as rush-out of a pedestrian, the autonomous vehicle autonomously makes an emergency stop. There are various surrounding situations of the vehicle after the vehicle makes an emergency stop, it is also difficult to predict next behaviors of a pedestrian or a bicycle which has caused the emergency stop. Therefore, it is difficult to appropriately judge whether or not the autonomous vehicle may restart driving after the emergency stop. On the other hand, in a case of an emergency stop in the center of a road, there is a possibility that vehicles are jammed behind, and it is required to promptly judge whether or not the autonomous vehicle may restart driving.

The first exemplary embodiment of the present disclosure has been made under such circumstances. A second object of the first exemplary embodiment is to provide a technology for suppressing prevention of road traffic while safety is ensured in an autonomous vehicle.

As mentioned above, in order to monitor the unmanned autonomous vehicle by the remote control center, sensed data obtained by sensing the state of the vehicle or the surrounding situation need to be received from the vehicle via a network, and to be displayed on a display-monitor. However, when a communication delay occurs, displacement may occur between actual situation and situation displayed on the display-monitor. As a result, a monitor (monitoring person) may make a wrong judgment based on wrong information.

The first exemplary embodiment of the present disclosure has been made under circumstances, a third object of the first exemplary embodiment is to provide a technology for improving accuracy of remote control by the monitoring person who monitors the autonomous vehicle via the network.

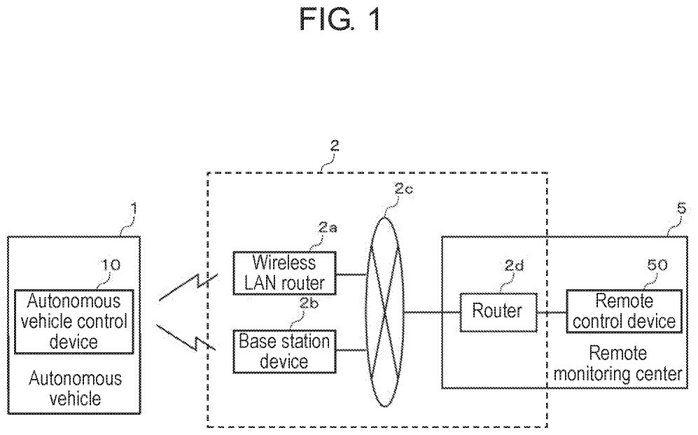

FIG. 1 is a diagram showing an entire configuration of a remote self-driving system according to the first exemplary embodiment of the present disclosure. Autonomous vehicle control device 10 installed in autonomous vehicle 1 communicates with remote control device 50 of remote monitoring center 5 via network 2. Autonomous vehicle control device 10 carries out interactive communication with remote control device 50 using a communication system using wireless LAN (Wireless Local Area Network) (hereinafter, referred to as a “first communication system”), and a communication system using a portable telephone network (cellular network) (hereinafter, referred to as a “second communication system”).

As of 2017, LTE (Long-Term Evolution) is widely available as a portable telephone network in Japan, and LTE covers almost all areas in urban areas. Base station device 2b has an area coverage range having a diameter of approximately several hundred meters to several kilometers, and each base station device 2b communicates with autonomous vehicle control devices 10 within its area coverage range by the second communication system. Base station device 2b transmits a signal received from autonomous vehicle control device 10 to remote control device 50 via an exchange station (not shown), a gateway device (not shown), the Internet 2c, and router 2d of remote monitoring center 5. Furthermore, base station device 2b receives a signal transmitted from remote control device 50 to autonomous vehicle control device 10 via router 2d of remote monitoring center 5, the Internet 2c, gateway device (not shown), and an exchange station (not shown), and transmits the signal to autonomous vehicle control device 10.

As of 2017, in Japan, the number of wireless LAN access points is increasing, but the area where the access points can be communicated with is limited. Furthermore, the number of free public wireless LAN access points is also increasing, but their places are limited to specific locations. It is expected that public wireless LAN access points will be placed continuously along major highways, in the future.

Wireless LAN router 2a has an area coverage range having a diameter of approximately several tens meters, and each base station device 2b communicates with autonomous vehicle control device 10 within its area coverage range by the first communication system. Wireless LAN router 2a transmits a signal received from autonomous vehicle control device 10 to remote control device 50 via internet 2c and router 2d of remote monitoring center 5. Furthermore, wireless LAN router 2a receives a signal transmitted from remote control device 50 to autonomous vehicle control device 10 via router 2d of remote monitoring center 5 and the Internet 2c, and transmits the signal to autonomous vehicle control device 10.

When unmanned autonomous vehicles are used for vehicles such as taxis, buses, and transport trucks, the greatest advantage is reduction in labor costs because a driver is not needed. Advantages by which a driver is not needed include an increase in the number of passengers who can get aboard and an increase in luggage space. However, in an unmanned autonomous vehicle, remote monitoring is required, and communication between the unmanned autonomous vehicle and the remote monitoring center is required. Under the current rate system of Japanese communication business in 2017, when high-quality picture shot by the in-vehicle camera is continuously transmitted to the remote monitoring center by the second communication system, communication cost would far exceed the wage of a driver. Therefore, in order to realize a remote self-driving system, it is necessary to reduce communication costs while safety is ensured.

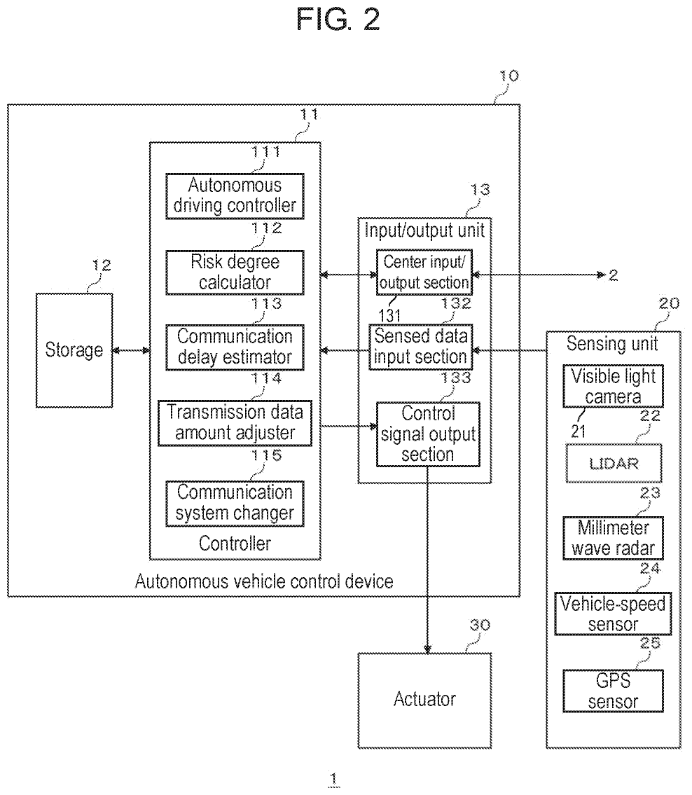

FIG. 2 is a diagram showing a configuration of autonomous vehicle 1 according to the first exemplary embodiment of the present disclosure. Autonomous vehicle 1 includes autonomous vehicle control device 10, sensing unit 20, and actuator 30. Members such as an accelerator pedal, a brake pedal, and a steering wheel, which are necessary to a driving operation by a driver, may be placed in a vehicle or may be omitted.

Actuator 30 drives a load such as an engine, a motor, a steering, a brake, and a lamp, to traveling of a vehicle. Sensing unit 20 includes visible light cameras 21, LIDAR (Light Detection and Ranging) 22, millimeter wave radar 23, vehicle-speed sensor 24, and GPS (Global Positioning System) sensor 25.

Visible light cameras 21 are placed in at least four positions in front, rear, right and left of the vehicle. The front picture, the rear picture, the left picture, and the right picture shot by these four visible light cameras 21 are combined to generate a bird's eye picture. Furthermore, visible light camera 21 for shooting the distance in the traveling direction is placed in front of the vehicle.

LIDAR 22 radiates a light beam (for example, an infrared laser) to the surrounding of the vehicle, receives the reflected signal thereof, and measures a distance with respect to an object existing in the surrounding, a size of the object, and a composition of the object, based on the received reflected signal. By placing a plurality of LIDARs 22 or mobile LIDAR 22, the moving speed of the object can also be measured. Furthermore, a three-dimensional modeling picture of the surrounding of the vehicle can be generated.

Millimeter wave radar 23 radiates an electric wave (millimeter wave) to the surrounding of the vehicle, receives the reflected signal thereof, and measures a distance to an object existing in the surrounding based on the received reflected signal. By placing a plurality of millimeter wave radars 23, an object in a wide range in the surrounding of the vehicle can be detected. Millimeter wave radar 23 can detect an object existing in more distance, which is difficult to be detected by LIDAR 22.

Vehicle-speed sensor 24 detects a speed of autonomous vehicle 1. GPS sensor 25 detects position information of autonomous vehicle 1. Specifically, GPS sensor 25 receives transmitting time from each of a plurality of GPS satellites, and calculates latitude and longitude of the receiving point based on the respective received transmitting times.

Autonomous vehicle control device 10 includes controller 11, storage 12 and input/output unit 13. Controller 11 includes autonomous driving controller 111, risk degree calculator 112, communication delay estimator 113, transmission data amount adjuster 114, and communication system changer 115. The functions of controller 11 can be implemented by cooperation of a hardware resource and a software resource, or by only a hardware resource. As the hardware resource, a processor, ROM (Read-Only Memory), RAM (Random-Access Memory), and other LSI (Large-Scale Integration) can be employed. As the processor, CPU (Central Processing Unit), GPU (Graphics Processing Unit), DSP (Digital Signal Processor), and the like, can be employed. As the software resource, programs such as an operating system and application can be utilized.

Storage 12 includes, for example, HDD (Hard Disk Drive), and/or SSD (Solid-State Drive). Storage 12 stores data such as a three-dimensional map necessary for autonomous traveling. Input/output unit 13 includes center input/output section 131, sensed data input section 132, and control signal output section 133. Center input/output section 131 has a communication interface that conforms to the communication system with respect to remote control device 50 of remote monitoring center 5. Sensed data input section 132 acquires various sensed data from sensing unit 20, and outputs them to controller 11. Control signal output section 133 outputs control signals to various actuators 30. The control signals are generated in controller 11 and configured to drive various actuators 30.

Autonomous driving controller 111 allows autonomous vehicle 1 to autonomously travel based on a predetermined self-driving algorithm. Specifically, autonomous driving controller 111 recognizes the situation of the vehicle and around the vehicle based on various types of sensed data sensed by detection unit 20 and various types of information collected from the outside by radio. Autonomous driving controller 111 applies various parameters indicating the recognized situation to the self-driving algorithm so as to determine an action of autonomous vehicle 1. Autonomous driving controller 111 generates various control signals for driving various actuators 30 based on the determined action, and outputs the signals to actuators 30, respectively.

The self-driving algorithm is generated by artificial intelligence (AI) based on deep learning. Various parameters of the self-driving algorithm are initialized to values previously learned by a high-specification computer, and updated values are downloaded from the data center on the cloud appropriately.

Risk degree calculator 112 calculates the current risk degree of autonomous vehicle 1 based on various parameters such as LDW (Lane Departure Warning), FCW (Forward collision warning), sudden steering, sudden braking, a time zone, a location, and weather. For example, when any one of events, such as LDW, FCW, sudden steering, and sudden braking occurs, the risk degree is largely increased.

Furthermore, risk degree calculator 112 may calculate a current risk degree of autonomous vehicle 1 based on risk prediction algorithm generated by artificial intelligence based on deep learning. In this case, the risk degree can be calculated with various data sensed by sensing unit 20 taken into account. The risk degree is defined by values in a range from, for example, 0 to 100.

Communication delay estimator 113 estimates delay time of a communication passage of the first communication system or second communication system. For example, communication delay estimator 113 can estimate the delay time from a difference between a transmission time at which a signal is transmitted from autonomous vehicle control device 10, and a receiving time at which the signal is received by remote control device 50. Specifically, by inserting a time stamp of the transmission time into the transmission signal, and by allowing the receiving time of the time stamp from remote control device 50, the difference is detected. Note here that when a time stamp is inserted into a signal transmitted from remote control device 50, a difference between the receiving time at which the signal is received and the transmission time included in the time stamp is detected.

Transmission data amount adjuster 114 adjusts a data amount of the sensed data to be transmitted to remote control device 50 based on the risk degree calculated by risk degree calculator 112 or the communication delay amount estimated by communication delay estimator 113. Transmission data amount adjuster 114 increases a data amount of the sensed data to be transmitted as the risk degree is higher or as the communication delay amount is smaller.

Among the above-mentioned sensed data of visible light camera 21, LIDAR 22, millimeter wave radar 23, vehicle-speed sensor 24, and GPS sensor 25, the amount of picture data generated by visible light camera 21 is the largest. The data amount of three-dimensional modeling data generated by LIDAR 22 is the second largest. The amount of sensed information sensed by millimeter wave radar 23 is the third largest. The amount of vehicle information sensed by vehicle-speed sensor 24 and position information sensed by GPS sensor 25 are very small.

Transmission data amount adjuster 114 can also adjust a data amount of transmission data by adjusting types of sensed data to be transmitted. For example, when data amount of data to be transmitted is reduced, transmission data amount adjuster 114 excludes the picture data generated by visible light camera 21 from the transmission target.

Furthermore, transmission data amount adjuster 114 can also adjust data amount of data to be transmitted by adjusting the picture quality of picture data to be transmitted. For example, transmission data amount adjuster 114 adjusts at least one of the resolution of the picture data and frame rate. Furthermore, gradation per unit pixel may be adjusted.

Communication system changer 115 switches a communication system based on the risk degree calculated by risk degree calculator 112 or the communication delay amount estimated by communication delay estimator 113. For example, communication system changer 115 compares a delay amount of the communication path in the first communication system and that in the second communication system, and selects a communication system with less delay amount among the first and second communication systems. Note here that in an area in which wireless LAN router 2a does not exist in the vicinity of autonomous vehicle 1, communication system changer 115 selects the second communication system.

Furthermore, communication system changer 115 selects a communication system with relatively higher quality when the risk degree calculated by risk degree calculator 112 is higher than a set value, and selects a communication system with relatively lower quality when the risk degree is the set value or less. Considering the communication quality of a mobile terminal during movement, the communication quality of the second communication system is higher than that of the first communication system. Individual cover range is wider and the frequency of hand-over is smaller in base station device 2b of portable telephone network than in wireless LAN router 2a. Furthermore, in the portable telephone network, a standard technology of hand-over is established, and there is little possibility that the communication is disconnected at a time of hand-over.

Also, communication system changer 115 can select a communication system with relatively higher communication cost when the risk degree calculated by risk degree calculator 112 is higher than a set value, and can select a communication system with relatively lower communication cost when the risk degree is the set value or less. When the public wireless LAN is used as the first communication system, the communication cost is lower in the first communication system than in the second communication system.

Note here that communication system changer 115 may select the first communication system having a relatively lower communication cost when the risk degree is lower than the set value even when the delay amount of the communication path in the first communication system is larger than that in the second communication system. However, when the delay amount of the communication path in the first communication system is absolutely larger, it is desirable to select the second communication system.

When an event that requires an emergency stop occurs, autonomous driving controller 111 transmits a control signal indicating an emergency stop to actuator 30 for braking so as to stop autonomous vehicle 1. Examples of the event that requires an emergency stop include rush-out of a person or a bicycle, a sudden stop of a leading vehicle, an interruption by another vehicle, communication failure. Note here that stopping at a red signal, stopping due to traffic jam, or stopping at a destination is not included in the emergency stop. Autonomous driving controller 111 causes autonomous vehicle 1 to make an emergency stop, and notifies remote control device 50 via network 2 that an event requiring an emergency stop has occurred.

When an event requiring the emergency stop occurs, transmission data amount adjuster 114 controls such that all types of sensed data sensed by sensing unit 20 are transmitted to remote control device 50. Therefore, picture data are also included in the transmission target. In addition, when an event requiring the emergency stop occurs, transmission data amount adjuster 114 controls such that picture data with the highest picture quality is transmitted to remote control device 50. Furthermore, when an event requiring the emergency stop occurs, communication system changer 115 selects a communication system having the smallest delay amount.

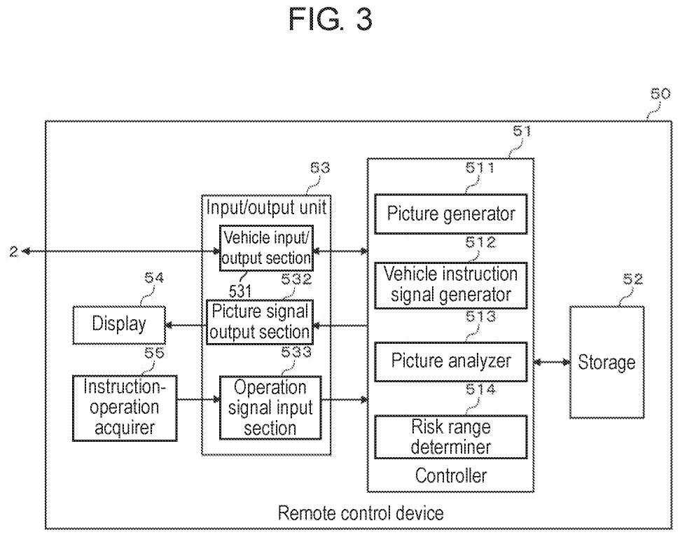

FIG. 3 is a diagram showing a configuration of remote control device 50 according to the first exemplary embodiment of the present disclosure. Remote control device 50 is constructed by at least one server or PC (Personal Computer). Remote control device 50 includes controller 51, storage 52, input/output unit 53, display 54, and instruction-operation acquirer 55. Display 54 includes a liquid crystal display or an organic EL (OEL: organic electro-luminescence) display, and displays a picture generated by controller 51. Instruction-operation acquirer 55 includes input devices such as a keyboard, a mouse, and a touch panel, and outputs an operation signal generated by an operation by a user to controller 51. Note here that instruction-operation acquirer 55 may be provided with simulated manipulating device such as a steering wheel, an accelerator pedal, and a brake pedal, but for remote driving, it is not essential in this exemplary embodiment.

Controller 51 includes picture generator 511, vehicle instruction signal generator 512, picture analyzer 513, and risk range determiner 514. A function of controller 51 can be implemented by cooperation of a hardware resource and a software resource, or by only a hardware resource. As the hardware resource, a processor, ROM, RAM, and other LSI, can be employed. As the processor, CPU, GPU, DSP, and the like, can be employed. As the software resource, programs such as an operating system and application can be utilized.

Storage 52 includes, for example, HDD, and/or SSD. Storage 52 stores data necessary to remote monitoring of autonomous vehicle 1, for example, a three-dimensional map synchronized to a three-dimensional map stored in storage 12 of autonomous vehicle control device 10. Input/output unit 53 includes vehicle input/output section 531, picture signal output section 532, and operation signal input section 533. Vehicle input/output section 531 has a communication interface that conforms a communication system with respect to autonomous vehicle control device 10 of autonomous vehicle 1. Picture signal output section 532 outputs a picture signal generated by controller 51 to display 54. Operation signal input section 533 inputs an operation signal accepted from instruction-operation acquirer 55 into controller 51.

Picture generator 511 generates a picture to be displayed on display 54, based on sensed data received from autonomous vehicle control device 10, and two-dimensional or three-dimensional map data. Picture generator 511 displays picture data shot by visible light camera 21 of autonomous vehicle 1, or a three-dimensional modeling picture generated by LIDAR 22 basically as it is on display 54. As to position information of autonomous vehicle 1, sensed by GPS sensor 25, or information of an object, sensed by millimeter wave radar 23, picture generator 511 generates picture on which an icon/pictogram of the vehicle or the object is superimposed on a corresponding positions on the two-dimensional/three-dimensional map.

In the remote self-driving system according to this exemplary embodiment, it is supposed that a user (hereinafter, referred to as a monitor or a monitoring person) of remote control device 50 determines an action of restarting driving after autonomous vehicle 1 makes an emergency stop by, and autonomous vehicle control device 10 determines the other actions of autonomous vehicle 1 autonomously in principle.

When vehicle instruction signal generator 512 accepts an operation signal based on a drive restarting operation by the monitor via operation signal input section 533 after autonomous vehicle 1 autonomously makes an emergency stop, vehicle instruction signal generator 512 transmits a drive restarting instruction signal to autonomous vehicle control device 10. Picture analyzer 513 and risk range determiner 514 are described later.

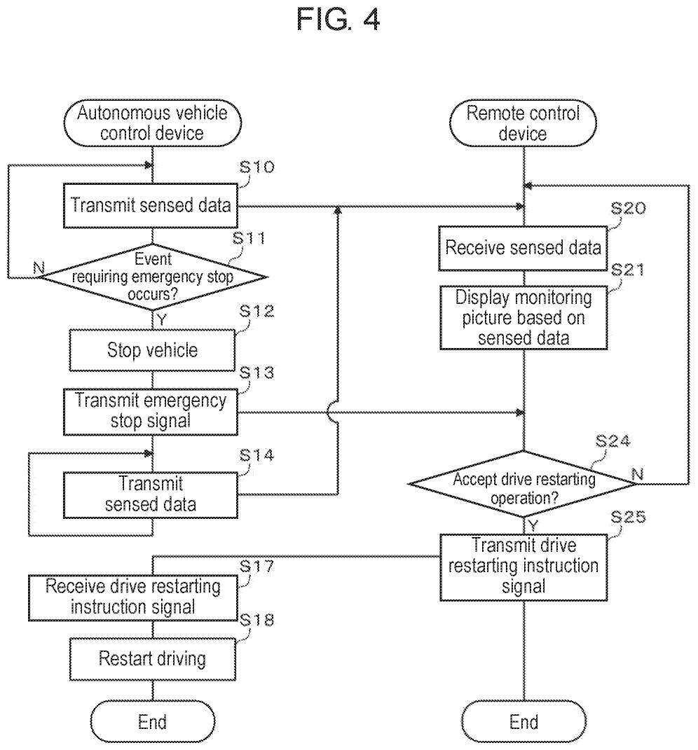

FIG. 4 is a flowchart showing a basic operation of the remote self-driving system according to the first exemplary embodiment of the present disclosure. Autonomous vehicle control device 10 transmits sensed data sensed by sensing unit 20 to remote control device 50 via network 2 (S10). Remote control device 50 receives the sensed data (S20), generates a monitoring picture based on the sensed data, and displays the monitoring picture on display 54 (S21).

When an event requiring an emergency stop occurs (Y in S11), autonomous vehicle control device 10 stops autonomous vehicle 1 (S12), and transmits an emergency stop signal to remote control device 50 via network 2 (S13). Also after the emergency stop, autonomous vehicle control device 10 continues to transmit the sensed data sensed by sensing unit 20 to remote control device 50 (S14).

Upon accepting a drive restarting operation carried out by the monitor who watches a monitoring picture displayed on display 54 (Y in S24), remote control device 50 transmits a drive restarting instruction signal to autonomous vehicle control device 10 via network 2 (S25). When autonomous vehicle control device 10 receives the drive restarting instruction signal (S17), autonomous vehicle control device 10 restarts driving of autonomous vehicle 1 (S18).

The following is an example of adaptively adjusting the amount of data transmitted from autonomous vehicle control device 10 in order to reduce the amount of communication between autonomous vehicle control device 10 and remote control device 50 while ensuring safety is secured.

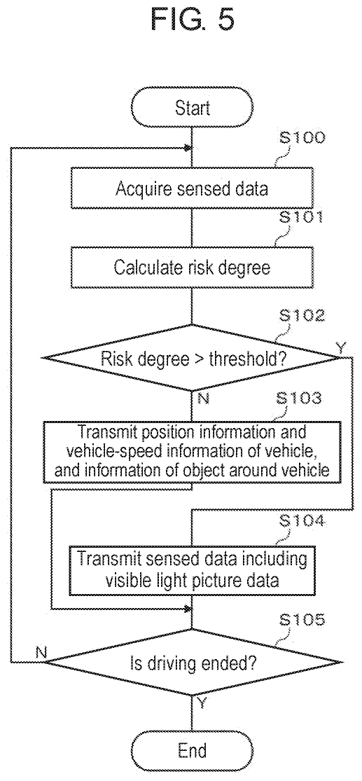

FIG. 5 is a flowchart showing a flow of processing of a method for adjusting transmission data amount according to operation example 1. Autonomous driving controller 111 of autonomous vehicle control device 10 acquires various sensed data from sensing unit 20 (S100). Autonomous travel controller 111 specifies position information of an object around the vehicle based on the sensed data acquired from at least one of visible light camera 21, LIDAR 22, and millimeter wave radar 23. The objects include a vehicle other than the vehicle equipped with autonomous vehicle control device 10, a bicycle, a pedestrian, an animal, and the like, which is preset as an obstacle during traveling in the self-driving algorithm. Note here that when at least one of the type of the object and a movement vector can be detected, at least one of the type of the object and the movement vector is also detected.

Risk degree calculator 112 calculates a current risk degree of the vehicle (S101). When the calculated risk degree is a preset threshold or less (N in S102), transmission data amount adjuster 114 selects position information of the vehicle sensed by GPS sensor 25, vehicle-speed information of the vehicle sensed by vehicle-speed sensor 24, and information of the object around the vehicle, as the sensed data to be transmitted to remote control device 50. Autonomous driving controller 111 transmits the sensed data including the position information of the vehicle, the vehicle-speed information of the vehicle, and the information of the object around the vehicle, which have been selected, to remote control device 50 via network 2 (S103).

When the above-mentioned risk degree exceeds the above-mentioned threshold (Yin S102), transmission data amount adjuster 114 includes visible light picture data captured by visible light camera 21 into the sensed data to be transmitted to remote control device 50. The sensed data includes the above-described position information of the vehicle, vehicle-speed information of the vehicle, and information of the object around the vehicle, in addition to the visible light picture data. Furthermore, three-dimensional modeling picture generated by LIDAR 22 may be included. Autonomous driving controller 111 transmits the sensed data including the visible light picture data to remote control device 50 via network 2 (S104). Processing of the steps S100 to S104 mentioned above are executed repeatedly (N in S105) until driving of autonomous vehicle 1 is ended (Y in S105).

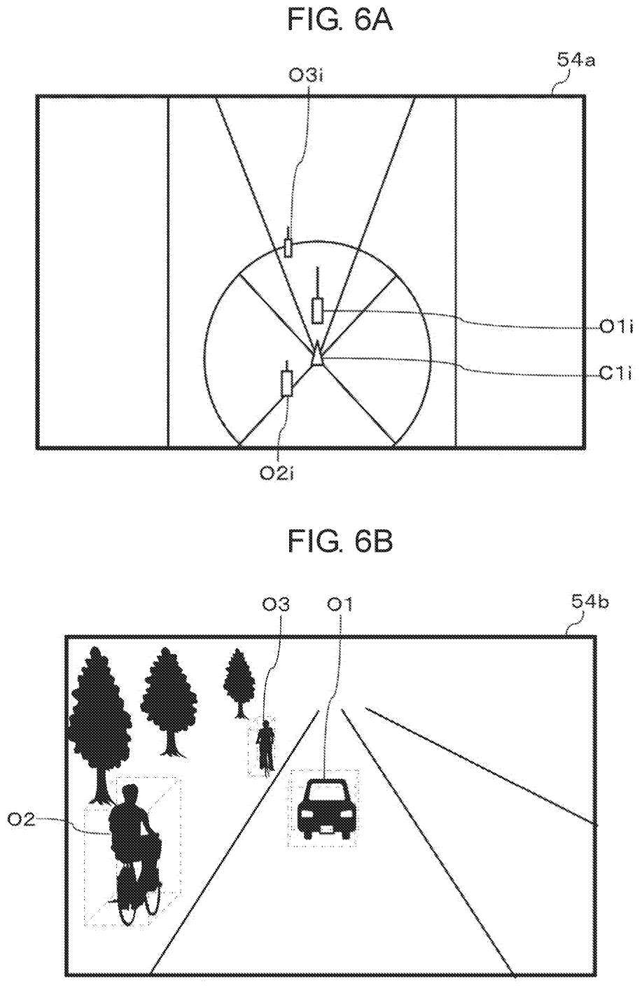

FIGS. 6A and 6B are views showing examples of monitoring pictures displayed on display 54 of remote control device 50 according to operation example 1. FIG. 6A shows one example of monitoring picture 54a displayed on display 54 in a state in which the above-mentioned risk degree is the above-mentioned threshold or less. The example shown in FIG. 6A shows icon C1i indicating the vehicle and three icons O1i to O3i indicating the object around the vehicle, based on the position information of the vehicle and the position information of the objects around the vehicle. Distance relation between the objects and the vehicle can be specified from the reflected signals detected by LIDAR 22 or millimeter wave radar 23. Furthermore, detecting a movement vector of an object allows the traveling direction of each object to be specified.

Note here that a bird's eye picture shown in FIG. 6A showing the relative position relation between the vehicle and the object may be superimposed on a two-dimensional map picture before displaying them. Picture generator 511 of remote control device 50 reads two-dimensional map data of an area corresponding to the position information of the vehicle from storage 52, and superimposes icon C1i indicating the vehicle and three icons O1i to O3i indicating the object around the vehicle on the two-dimensional map.

FIG. 6B is a view showing one example of monitoring picture 54b displayed on display 54 in a state in which the above-mentioned risk degree exceeds the above-mentioned threshold. The example shown in FIG. 6B shows a visible light picture generated by visible light camera 21 shooting the area in front of the vehicle. A leading vehicle as first object O1, a bicycle as second object O2, and a bicycle as a third object O3 are displayed as actually shot images.

According to operation example 1, in a state in which the risk degree is low, the picture data are not transmitted to remote control device 50, and thereby the transmission data amount can be largely reduced. Meanwhile, the risk degree is high, the picture data are transmitted, and thereby the monitor of remote monitoring center 5 can check the situation around the vehicle by the actually shot images. Therefore, in a state in which the risk degree is high, it is possible to secure a sufficient monitoring condition by the monitor.

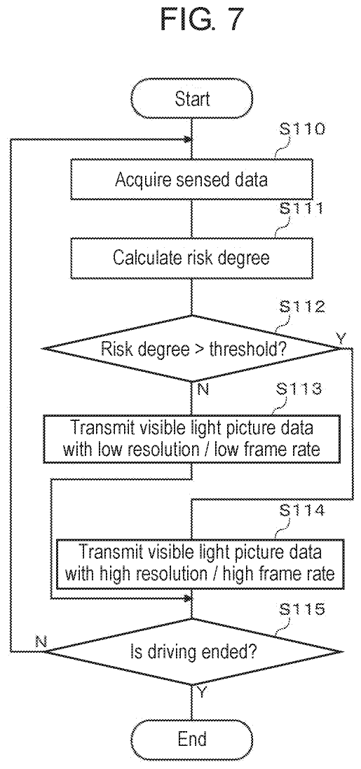

FIG. 7 is a flowchart showing a flow of processing of a method for adjusting transmission data amount according to operation example 2. Autonomous driving controller 111 of autonomous vehicle control device 10 acquires various sensed data from sensing unit 20 (S110). Risk degree calculator 112 calculates the current risk degree of the vehicle (S111). When the calculated risk degree is the preset threshold or less (N in S112), transmission data amount adjuster 114 includes at least one of visible light picture data having relatively low resolution and low frame rate into the sensed data to be transmitted to remote control device 50. The sensed data includes the position information of the vehicle, vehicle-speed information of the vehicle, and information of the object around the vehicle mentioned above, in addition to the visible light picture data. Autonomous driving controller 111 transmits the sensed data including the visible light picture data to remote control device 50 via network 2 (S113).

When the above-mentioned risk degree exceeds the above-mentioned threshold (Y in S112), transmission data amount adjuster 114 includes visible light picture data having at least one of relatively high resolution and high frame rate into the sensed data to be transmitted to remote control device 50. The sensed data includes the position information of the vehicle, the vehicle-speed information of the vehicle, and information of the object around the vehicle mentioned above, in addition to the visible light picture data. Autonomous driving controller 111 transmits the sensed data including the visible light picture data to remote control device 50 via network 2 (S114). Processing of step S110 to step S114 mentioned above are repeatedly executed (N in S115) until the driving of autonomous vehicle 1 is ended (Y in S115).

The picture with relatively high resolution includes, for example, pictures of HD (High-Definition) picture quality, full HD picture quality, and 4K picture quality. The picture with relatively low resolution includes, for example, pictures of QVGA (Quarter Video Graphics Array) picture quality, VGA (Video Graphics Array) picture quality, and HD picture quality. The picture with relatively high frame rate include, for example, picture of 15 fps, 30 fps, or 60 fps. The picture with relatively low frame rate include, for example, pictures of 3 to 7 fps, or 15 fps.

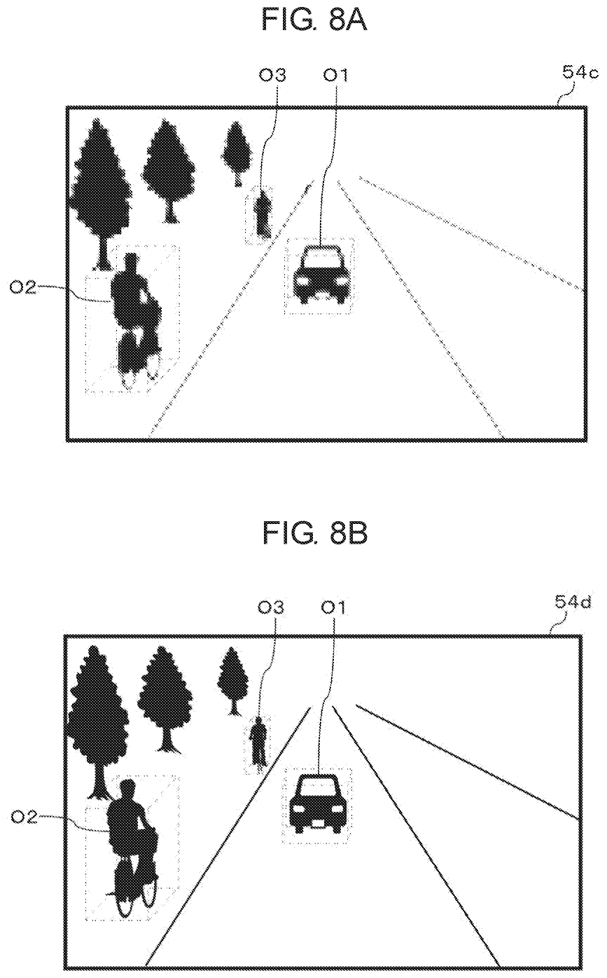

FIG. 8A and FIG. 8B are views showing examples of monitoring pictures displayed on display 54 of remote control device 50 according to operation example 2. FIG. 8A shows one example of monitoring picture 54c displayed on display 54 in a state in which the above-mentioned risk degree is the above-mentioned threshold or less. The example shown in FIG. 8A shows a visible light picture with relatively low resolution received from autonomous vehicle control device 10. FIG. 8B shows one example of monitoring picture 54d displayed on display 54 in a state in which the above-mentioned risk degree exceeds the above-mentioned threshold. The example shown in FIG. 8B shows a visible light picture with relatively high resolution received from autonomous vehicle control device 10.

According to operation example 2, in a state in which the risk degree is low, by transmitting picture data having at least one of a low resolution and a low frame rate to remote control device 50, the amount of data to transmit can be reduced. Meanwhile, in a state in which the risk degree is high, by transmitting picture data having at least one of a high resolution and a high frame rate, it is possible to secure a sufficient monitoring condition by the monitor.

Note here that as the modified examples of operation examples 1 and 2, when the above-mentioned risk degree is the above-mentioned threshold or less, sensed data including a three-dimensional modeling picture sensed by LIDAR 22 may be transmitted from autonomous vehicle control device 10, and the three-dimensional modeling picture may be displayed on display 54 of remote control device 50. The three-dimensional modeling picture is a distance picture drawn in a gray scale in which the density is changed in accordance with the distance to the reflection object, and has lower the resolution as compared with the visible light picture. Therefore, also when a three-dimensional modeling image is transmitted instead of the visible light image, the amount of data can be reduced.

The following is a description of an example in which a communication system is adaptively switched in order to reduce the cost of the communication between autonomous vehicle control device 10 and remote control device 50 while safety is ensured.

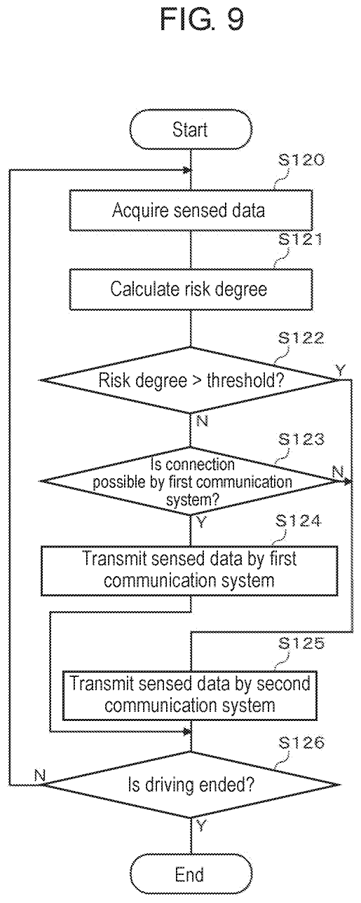

FIG. 9 is a flowchart showing a flow of processing of a communication system switching method according to operation example 3. Autonomous driving controller 111 of autonomous vehicle control device 10 acquires various sensed data from sensing unit 20 (S120). Risk degree calculator 112 calculates the current risk degree of the vehicle (S121). When the calculated risk degree is a preset threshold or less (N in S122), communication system changer 115 determines whether or not connection is possible by the first communication system (S123). When wireless LAN router 2a is not present in the vicinity of the vehicle, connection is impossible. When connection can be established by the first communication system (Yin S123), communication system changer 115 selects the first communication system, and autonomous driving controller 111 transmits the acquired sensed data to remote control device 50 using the first communication system (S124).

When the above-mentioned risk degree exceeds the above-mentioned threshold in step S122 (Y in S122), or when connection cannot be established by the first communication system in step S123 (N in S123), communication system changer 115 selects the second communication system, and autonomous driving controller 111 transmits the acquired sensed data to remote control device 50 using the second communication system (S125). The processing of the steps S120 to S125 mentioned above are executed repeatedly (N in S126) until the driving of autonomous vehicle 1 is ended (Y in S126).

According to operation example 3, in a state in which the risk degree is low, use of the first communication system can reduce the communication cost. Meanwhile, in a state in which the risk degree is high, use of the second communication system can maintain the communication quality at relatively high state, and secure a sufficient monitoring condition by the monitor.

The following is a description of an example in which the communication system is switched adaptively in order to reduce the amount of communication delay between autonomous vehicle control device 10 and remote control device 50 as possible.

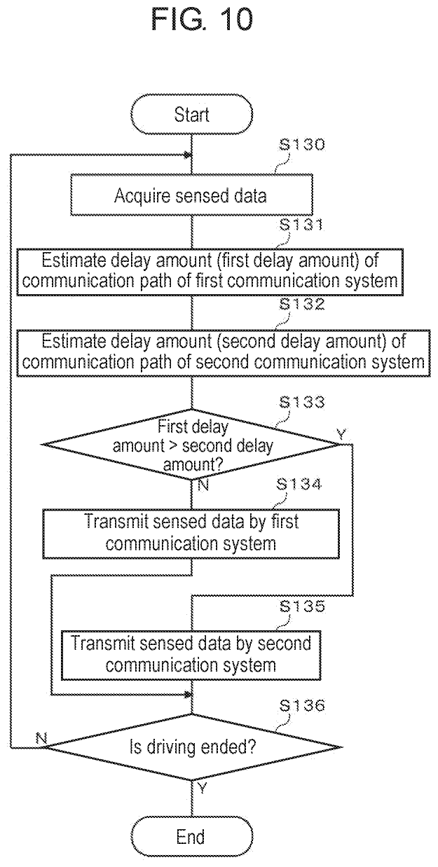

FIG. 10 is a flowchart showing a flow of processing of a communication system switching method according to operation example 4. Autonomous driving controller 111 of autonomous vehicle control device 10 acquires various sensed data from sensing unit 20 (S130). Communication system changer 115 estimates a communication delay amount of the communication path of the first communication system (hereinafter, referred to as a “first delay amount”) (S131). Communication system changer 115 estimates a communication delay amount of the communication path of the second communication system (hereinafter, referred to as a “second delay amount”) (S132).

When the first delay amount is equal to or less than the second delay amount (N in S133), communication system changer 115 selects the first communication system, and autonomous driving controller 111 transmits the acquired sensed data to remote control device 50 using first communication system (S134). When the first delay amount is larger than the second delay amount (Y in S133), communication system changer 115 selects the second communication system, and autonomous driving controller 111 transmits the acquired sensed data to remote control device 50 using second communication system (S135). Processing of the step S130 to step S135 mentioned above are repeatedly executed (N in S136) until the driving of autonomous vehicle 1 is ended (Y in S136).

According to operation example 4, when the communication system having a smaller communication delay amount is selected, an amount of communication delay between autonomous vehicle control device 10 and remote control device 50 can be reduced as possible. Note here that processing shown in FIG. 10 is executed when the above-mentioned risk degree exceeds the above-mentioned threshold. When the above-mentioned risk degree is the above-mentioned threshold or less, even when the first delay amount is larger, the first communication system may be selected preferentially. In the example, in a state in which the risk degree is low, the reduction of the communication cost is selected preferentially.

In the above-mentioned operation example 1, in a state in which the risk degree is low, the monitor of remote monitoring center 5 cannot watch an actually shot images. Furthermore, in the above-mentioned operation example 2, in a state in which the risk degree is low, the monitor cannot watch pictures other than a picture with low picture quality. When the monitor predicts a risk earlier than autonomous vehicle control device 10 does, or when the monitor has some uncomfortable feeling, there's a case where the monitor would like to watch a picture with high picture quality around autonomous vehicle 1.

Upon accepting an operation signal based on a high-quality picture request operation from a monitor via operation signal input section 533, vehicle instruction signal generator 512 of remote control device 50 transmits a high-quality picture request signal to autonomous vehicle control device 10. Upon receiving the high-quality picture request signal, transmission data amount adjuster 114 of autonomous vehicle control device 10 allows remote control device 50 to transmit picture data with high picture quality to autonomous driving controller 111.

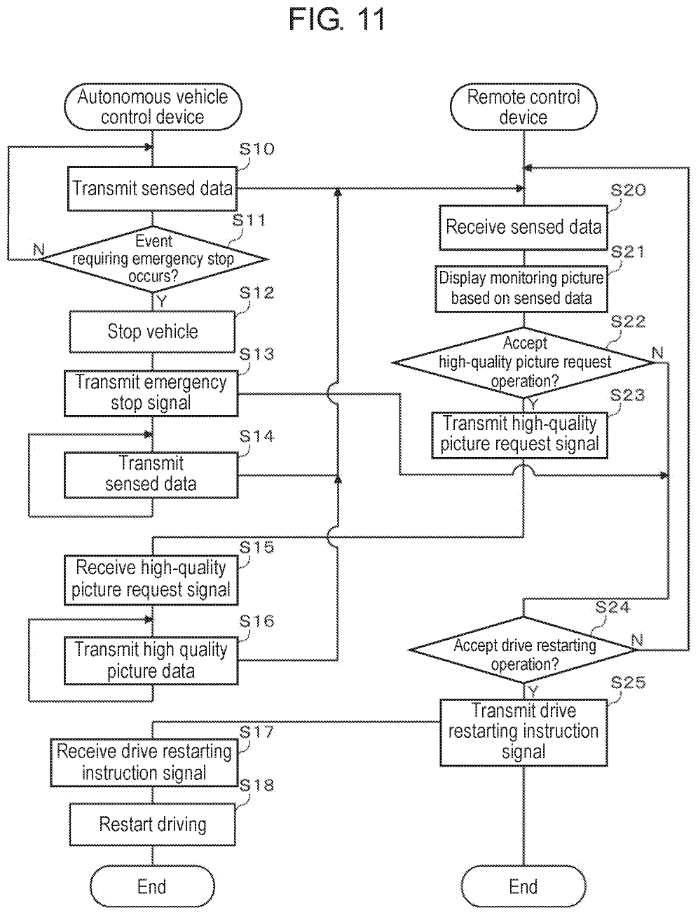

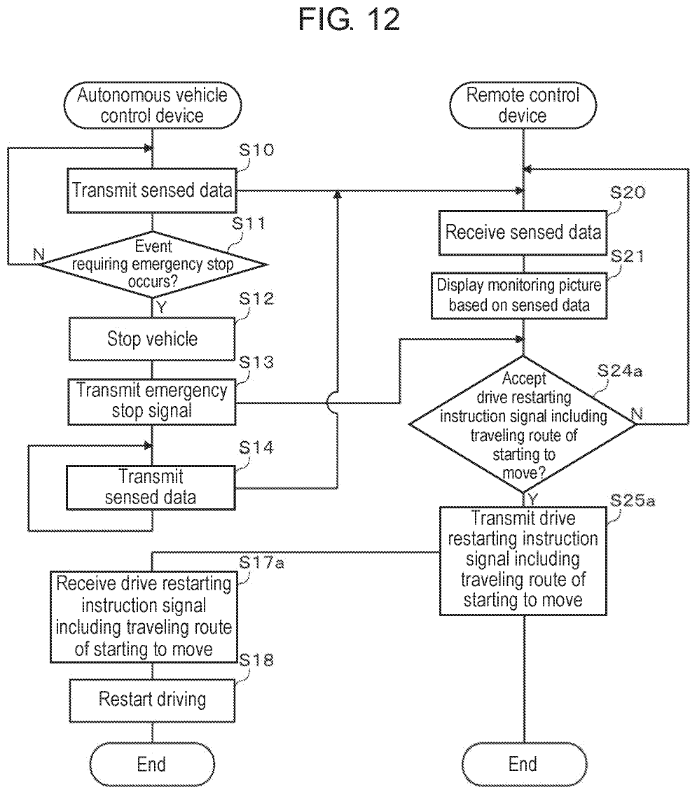

FIG. 11 is a flowchart showing an operation of a remote self-driving system equipped with a high-quality picture request function according to operation example 5. Autonomous vehicle control device 10 transmits the sensed data sensed by sensing unit 20 to remote control device 50 via network 2 (S10). Remote control device 50 receives the sensed data (S20), generates a monitoring picture based on the sensed data, and displays the monitoring picture on display 54 (S21). When remote control device 50 accepts a high-quality picture request operation by the monitor who watches a monitoring picture displayed on display 54 (Y in S22), remote control device 50 transmits the request signal to autonomous vehicle control device 10 via network 2 (S23). When autonomous vehicle control device 10 receives a high-quality picture request signal (S15), autonomous vehicle control device 10 transmits picture data with high picture quality to remote control device 50 via network 2 (S16).

When an event requiring an emergency stop occurs (Y in S11), autonomous vehicle control device 10 stops autonomous vehicle 1 (S12), and transmits an emergency stop signal to remote control device 50 via network 2 (S13). Also after the emergency stop, autonomous vehicle control device 10 continues to transmit the data sensed by sensing unit 20 to remote control device 50 (S14).

Upon accepting a drive restarting operation carried out by the monitor who watches the monitoring picture displayed on display 54 (Y in S24), remote control device 50 transmits a drive restarting instruction signal to autonomous vehicle control device 10 via network 2 (S25). Upon receiving the drive restarting instruction signal (S17), autonomous vehicle control device 10 restarts driving of autonomous vehicle 1 (S18).

According to operation example 5, when the monitor wants to see a high quality picture, the monitor can switch the picture to be displayed to high quality picture. Thus, it is possible to secure a sufficient monitoring condition by the monitor.

In the above description, the monitor only carries out a drive restarting operation. Specific timing of restarting driving and a traveling route of starting to move at a time of restarting driving are determined by autonomous vehicle control device 10. However, it may be difficult for autonomous vehicle control device 10 that receives instruction to restart driving from remote control device 50 to autonomously restart driving. Examples of the case include a case where an obstacle that is difficult to avoid is detected. Specific examples of the cases include a case where there is no traveling space to avoid an obstacle, a case where passing over the center line is required, or a case where passing over in a curve or in a crosswalk is required. In addition, a case where a vehicle stops when it encounters an oncoming vehicle on a narrow road is also included in the examples of the cases. Also, in the case of an emergency stop due to traffic control by a traffic check, an accident, or road construction, it is difficult for autonomous vehicle control device 10 to determine the timing of restarting driving and the traveling route of starting to move at the time of restarting driving. Thus, it is considered that the monitor designates the traveling route of starting to move at the time of restarting driving.

FIG. 12 is a flowchart showing an operation of a remote self-driving system equipped with a designating function of the traveling route at the time of restarting driving according to operation example 6. Autonomous vehicle control device 10 transmits sensed data sensed by sensing unit 20 to remote control device 50 via network 2 (S10). Remote control device 50 receives the sensed data (S20), generates a monitoring picture based on the sensed data, and displays the monitoring picture on display 54 (S21).

When an event requiring an emergency stop occurs (Y in S11), autonomous vehicle control device 10 stops autonomous vehicle 1 (S12), and transmits an emergency stop signal to remote control device 50 via network 2 (S13). Also after the emergency stop, autonomous vehicle control device 10 continues to transmit the sensed data sensed by sensing unit 20 to remote control device 50 (S14).

Upon accepting a drive restarting operation including designation of a traveling route of starting to move at the time of restarting driving, which is carried out by a monitor who watches the monitoring picture displayed on display 54 (Y in S24a), remote control device 50 transmits a drive restarting instruction signal including the traveling route of starting to move to autonomous vehicle control device 10 via network 2 (S25a). When autonomous vehicle control device 10 receives the drive restarting instruction signal including the traveling route of starting to move (S17a), autonomous vehicle control device 10 allows autonomous vehicle 1 to restart driving on the traveling route (S18).

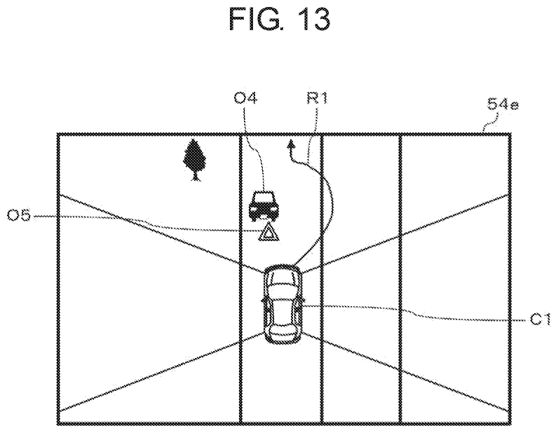

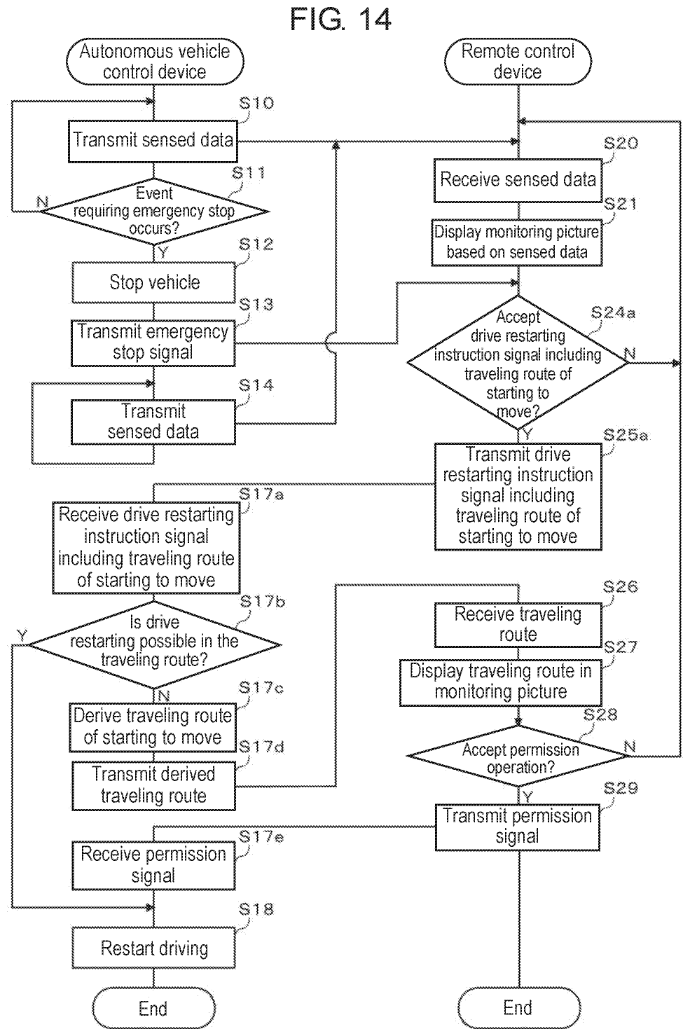

FIG. 13 is a view showing one example of a case where a traveling route is designated on monitoring picture 54e displayed on display 54 of remote control device 50 according to operation example 6. Monitoring picture 54e shown in FIG. 13 is a bird's eye picture including the vehicle. In monitoring picture 54e, a vehicle that stops due to failure in the front side is detected as fourth object O4, and a triangular guide plate is detected as fifth object O5. In this state, autonomous traveling controller 111 of autonomous vehicle control device 10 causes the vehicle to make an emergency stop based on the approaching of the distance between the vehicle and fourth object O4 or the detection of fifth object O5. Autonomous driving controller 111 basically has an algorithm of not passing over the center line.

A monitor designates traveling route R1 for starting to move at the time of restarting driving, by drawing a trajectory on a touch panel display by the his/her finger. The trajectory may be drawn by a pointing device such as a stylus pen. Note here that in a case of a display without having a touch panel function, traveling route R1 is designated by a mouse operation.

According to operation example 6, even when it is difficult for autonomous driving controller 111 to determine the traveling route at the time of restarting driving after autonomous vehicle control device 10 makes the emergency stop, the monitor designates the traveling route at the time of restarting driving, thus, driving can be restarted quickly. Therefore, it is possible to avoid event that autonomous vehicle 1 stops at a certain place for a long time and prevents road traffic. Note here that when there's no traveling route for autonomous vehicle 1 to avoid the obstacle, the monitor can change a movement route to destination and to allow autonomous vehicle 1 to make a U-turn.

In operation example 6, the traveling route designated by the monitor may be a route that cannot be traveled physically or due to safety standards. For example, when a physically impassable route is designated, or when the vehicle cannot travel safely due to a change in the situation, autonomous driving controller 111 of autonomous vehicle control device 10 rejects the travel route designated by remote control device 50. Thereafter, autonomous driving controller 111 autonomously determines a travel route in accordance with the current situation, and notifies remote control device 50 of the travel route to request permission. Note here that when the traveling route cannot be physically secured, autonomous driving controller 111 notifies the remote control device 50 that the traveling is impossible.

FIG. 14 is a flowchart showing an operation of a remote self-driving system equipped with a designating function of a traveling route at the time of restarting driving according to operation example 7. Autonomous vehicle control device 10 transmits sensed data sensed by sensing unit 20 to remote control device 50 via network 2 (S10). Remote control device 50 receives the sensed data (S20), generates a monitoring picture based on the received sensed data, and displays the monitoring picture on display 54 (S21).

When an event requiring an emergency stop occurs (Y in S11), autonomous vehicle control device 10 stops autonomous vehicle 1 (S12), and transmits an emergency stop signal to remote control device 50 via network 2 (S13). Also after the emergency stop, autonomous vehicle control device 10 continues to transmit the sensed data sensed by sensing unit 20 to remote control device 50 (S14).

Upon accepting a drive restarting operation including designation of a traveling route for starting to move at the time of restarting driving, which is carried out by a monitor who watches the monitoring picture displayed on display 54 (Y in S24a), remote control device 50 transmits a drive restarting instruction signal including the traveling route for starting to move to autonomous vehicle control device 10 via network 2 (S25a).

When autonomous vehicle control device 10 receives the drive restarting instruction signal including the traveling route of starting to move (S17a), autonomous vehicle control device 10 determines whether or not restarting driving is possible on the traveling route physically or in terms of safety standard (S17b). When the driving is possible (Y in S17b), autonomous vehicle control device 10 allows autonomous vehicle 1 to restart driving on the traveling route is restarted (S18). When the driving is not possible (N in S17b), autonomous vehicle control device 10 derives an optimum traveling route in accordance with the current situation (S17c), and transmits the derived traveling route to remote control device 50 via network 2 (S17d).

Remote control device 50 receives the traveling route (S26), and displays the received traveling route in a monitoring picture (S27). When remote control device 50 accepts an operation that permits the traveling route and is carried out by the monitor who watches the monitoring picture (Y in S28), remote control device 50 transmits a permission signal for the traveling route to autonomous vehicle control device 10 via network 2 (S29). When autonomous vehicle control device 10 receives the permission signal (S17e), autonomous vehicle control device 10 restarts driving on the traveling route (S18). Note here that when the monitor does not permit the traveling route, the monitor needs to designate a new traveling route.

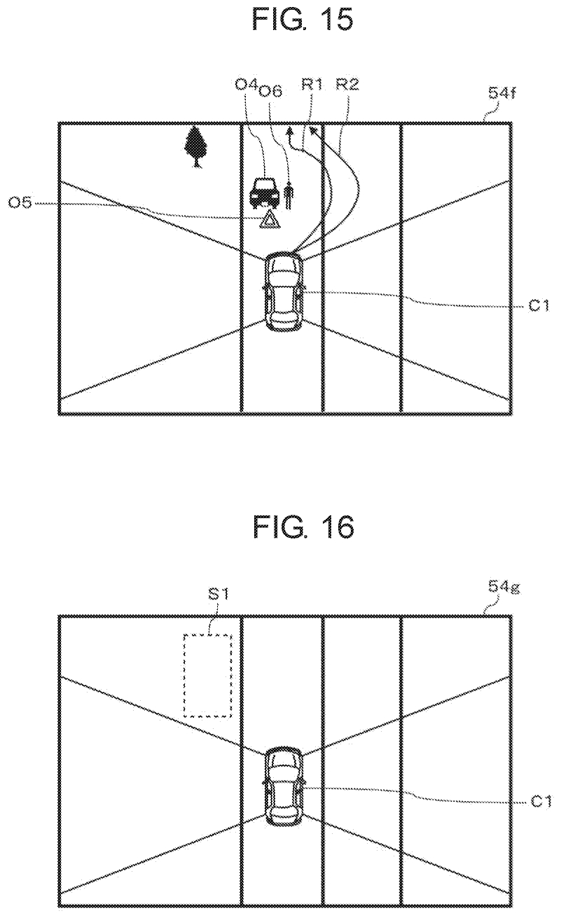

FIG. 15 is a view showing one example of a case where a traveling route is designated on monitoring picture 54f displayed on display 54 of remote control device 50 according to operation example 7. Traveling route R1 on monitoring picture 54f shown in FIG. 15 is designated on monitoring picture 54e shown in FIG. 13 by a monitor. Monitoring picture 54f shown in FIG. 15 shows a situation in which a person gets off from a vehicle during stopping due to failure after the monitor designates a traveling route. When autonomous driving controller 111 detects the person who gets off from the vehicle as sixth object O6, autonomous driving controller 111 rejects the traveling route designated by the monitor, and derives traveling route R2 passing through a position that is more distant from sixth object O6. Autonomous driving controller 111 transmits derived traveling route R2 to remote control device 50, and traveling route R2 is displayed on display 54 of remote control device 50.

According to operation example 7, when the traveling route at the time of restarting driving designated by the monitor cannot be traveled physically or by safety standards, autonomous vehicle control device 10 derives the other traveling route that can be traveled, and transmits the derived route to remote control device 50 to request permission. This can improve safety at the time of restarting driving.

In operation examples 6 and 7, the monitor designates the traveling route by designating a moving trajectory of autonomous vehicle 1. In this regard, the traveling route may be designated by designating a target location of a destination. For example, when it is desired to temporarily move the vehicle to the shoulder of the road, the predetermined position of the shoulder is designated.

FIG. 16 is a view showing one example of a case where a traveling route is designated on monitoring picture 54g displayed on display 54 of remote control device 50 according to a modified example of operation examples 6 and 7. In monitoring picture 54g shown in FIG. 16, a monitor designates target location si of the destination. For example, points at four corners of target location si may be designated. Autonomous driving controller 111 of autonomous vehicle control device 10 sets target location si of the destination designated by remote control device 50 as a new destination and restarts autonomous traveling toward the destination.

As described above, judgment of restarting driving after an emergency stop of autonomous vehicle 1 is made by a monitor of remote monitoring center 5. In order to improve accuracy of judgment by the monitor, it is necessary to give an appropriate judgment material to the monitor. In order to avoid a risk occurring at the time of restarting driving autonomous vehicle 1, the monitor needs to check that an obstacle does not exist in the surrounding of autonomous vehicle 1. Presenting objective criteria regarding a range of the object, which allows restarting driving, is useful information in judging restating of driving and reduces variation in the judgment. Thus, it is considered to superimpose a risk range object showing a risk range onto the surrounding of autonomous vehicle 1 shown in display 54 of remote control device 50.

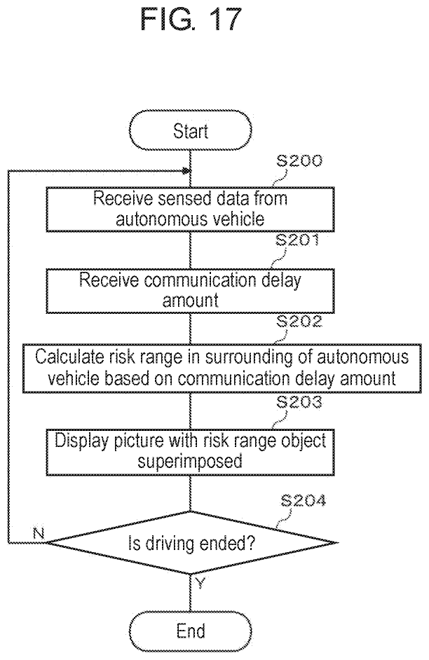

FIG. 17 is a flowchart showing a flow of processing of a displaying method of a monitoring picture including a risk range object according to operation example 8. Picture generator 511 of remote control device 50 receives sensed data from autonomous vehicle control device 10 via network 2 (S200). Risk range determiner 514 receives an amount of a communication delay between autonomous vehicle control device 10 and remote control device 50 from autonomous vehicle control device 10 via network 2 (S201). Note here that the communication delay amount may be estimated by remote control device 50.

Risk range determiner 514 determines the risk range of the surrounding of autonomous vehicle 1 based on the received communication delay amount (S202). Risk range determiner 514 widens the risk range as the communication delay amount is larger. Picture generator 511 generates a risk range object corresponding to the calculated risk range, and generates a monitoring picture on which the generated risk range object is superimposed on autonomous vehicle 1. Picture generator 511 displays the generated monitoring picture on display 54 (S203). Processing of the steps S200 to S203 mentioned above are executed repeatedly (N in S204) until driving of autonomous vehicle 1 is ended (Y in S204).

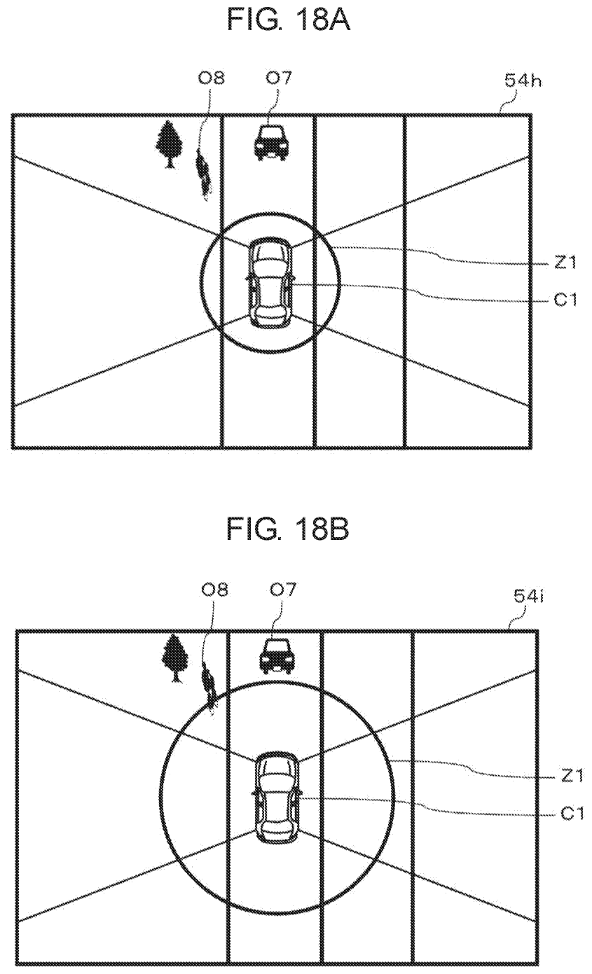

FIGS. 18A and 18B are views showing examples of monitoring pictures displayed on display 54 of remote control device 50 according to operation example 8. FIG. 18A shows one example of monitoring picture 54h displayed on display 54 in a state in which the above-mentioned communication delay amount is relatively small. In monitoring picture 54h, a leading vehicle is detected as seventh object O7, and a bicycle is detected as eighth object O8. Circular risk range object Z1 around the position of the vehicle is superimposed and displayed on an actually shot image.

FIG. 18B shows one example of monitoring picture 54i displayed on display 54 in a state in which the above-mentioned communication delay amount is relatively large. As compared with FIG. 18A, risk range object Z1 is enlarged. As the communication delay amount is larger, the reliability of the monitoring picture is deteriorated. Accordingly, the risk range is displayed in larger size. Note here that the shape of risk range object Z1 is not limited to a perfect circle, and it may be an ellipse spreading in the traveling direction. Alternatively, it may have a polygonal shape.

Even when an event that requires an emergency stop does not objectively occur, autonomous driving controller 111 may cause autonomous vehicle 1 to make an emergency stop due to misdetection by the sensor. In this case, the monitor of remote monitoring center 5 is required to quickly instruct to restart driving of autonomous vehicle 1. At that time, when risk range object Z1 is displayed in monitoring pictures 54h and 54i, the monitor can judge whether to restart driving or not instantaneously. In other words, if there is no obstacle in the risk range object Z1, it can be judged objectively and uniquely that the driving can be restarted safely.

Risk range object Z1 contributes to clarifying a responsible range of the monitor. That is to say, when the monitor instructs to restart driving in a state in which no obstacle is present in risk range object Z1, the monitor is exempted from being responsible even when a risk occurs due to a sudden event in the surrounding of autonomous vehicle 1.

According to operation example 8, displaying a monitoring picture with a risk range object superimposed thereon allows accuracy of judgment to restart driving by the monitor to be improved. Furthermore, dynamically changing the size of a risk range object in accordance with the communication delay amount allows an error with respect to an actual risk range by the communication delay amount to be compensated.

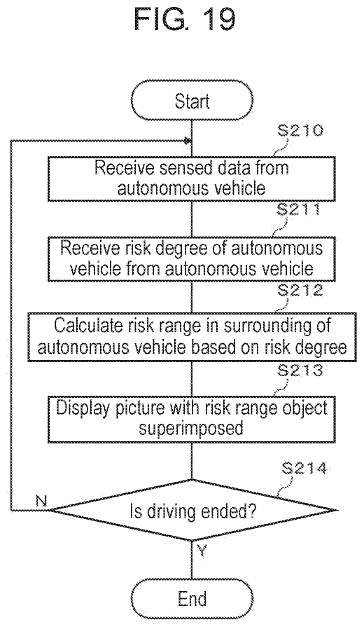

FIG. 19 is a flowchart showing a flow of processing of a displaying method of a monitoring picture including a risk range object according to operation example 9. Picture generator 511 of remote control device 50 receives sensed data from autonomous vehicle control device 10 via network 2 (S210). Risk range determiner 514 receives the risk degree of autonomous vehicle control device 10 from autonomous vehicle control device 10 via network 2 (S211).

Risk range determiner 514 determines a risk range in the surrounding of autonomous vehicle 1 based on the received risk degree (S212). Risk range determiner 514 widens the risk range as the risk degree is high. Picture generator 511 generates a risk range object corresponding to the calculated risk range, and generates a monitoring picture in which the generated risk range object is superimposed on autonomous vehicle 1. Picture generator 511 displays the generated monitoring picture on display 54 (S213). Processing of the step S210 to step S213 mentioned above are repeatedly carried out (N in S214) until the driving of autonomous vehicle 1 is ended (Y in S214).

According to operation example 9, displaying a monitoring picture with a risk range object superimposed thereon allows accuracy of judgment to restart driving by the monitor to be improved. Furthermore, dynamically changing the size of the risk range object in accordance with the risk degree of autonomous vehicle 1 allows safety at the time of restarting driving to be sufficiently secured.

In order to improve the accuracy of judgment to restart driving by the monitor, it is necessary to consider an error due to the communication delay. It is thought that visualizing and displaying the communication delay in the monitoring picture allows the monitor to intuitively recognize the communication delay.

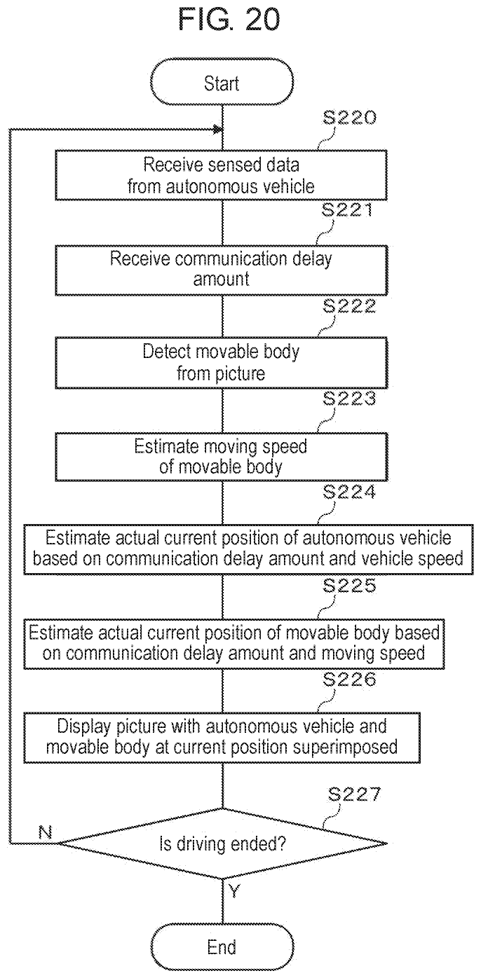

FIG. 20 is a flowchart showing a flow of processing of a displaying method of a monitoring picture in which a communication delay is visualized according to operation example 10. Picture generator 511 of remote control device 50 receives sensed data from autonomous vehicle control device 10 via network 2 (S220). The sensed data also includes vehicle-speed information of autonomous vehicle 1. Picture generator 511 receives an amount of a communication delay between autonomous vehicle control device 10 and remote control device 50 from autonomous vehicle control device 10 via network 2 (S221). Note here that the communication delay amount may be estimated by remote control device 50.

Picture analyzer 513 detects a moving object from each frame of the received picture data (S222). Picture analyzer 513 searches the frames using an identifier of a moving object registered in advance so as to be recognized as an obstacle, and detects the moving object. Picture analyzer 513 estimates the moving speed of the moving object detected in the frames of the picture data (S223). Picture analyzer 513 detects a difference between a position of the moving object detected in the current frame and a position of the moving object detected in the past frame to detect a movement vector of the moving object. Picture analyzer 513 sequentially detects the movement vectors each between two continuous frames, and calculates an average value of the detect movement vectors so as to estimate the moving speed of the moving object. Note here that moving speed of the moving object may be detected by an optical flow method.

Picture analyzer 513 estimates an actual current position of autonomous vehicle 1 based on the received communication delay amount and the vehicle speed of autonomous vehicle 1 (S224). Picture analyzer 513 estimates a position where the vehicle speed (speed per second) multiplied by the communication delay amount is moved in the traveling direction of autonomous vehicle 1 as the current position of autonomous vehicle 1. The traveling direction of autonomous vehicle 1 can be estimated by detecting, for example, a movement vector of the position information sensed by GPS sensor 25.

Picture analyzer 513 estimates an actual current position of the moving object based on the received communication delay amount and the estimated moving speed of a moving object (S225). Picture analyzer 513 estimates a position where the vehicle speed (speed per second) multiplied by the communication delay amount is shifted in the traveling direction of the moving object as a current position of the moving object.

Picture generator 511 generates a monitoring picture on which autonomous vehicle 1 and the moving object at the respective estimated current positions are superimposed (S226). In the monitoring picture, autonomous vehicle 1 and the moving object specified by picture data, and autonomous vehicle 1 and the moving object at the estimated current position are indicated together. The above-mentioned processing of the step S220 to step S226 mentioned above are carried out repeatedly (N in S227) until the driving of autonomous vehicle 1 is ended (Y in S227). Note here that when the position, the traveling direction, and the moving speed of the moving object can be received from autonomous vehicle control device 10, processing of step S222 and step S223 can be omitted.

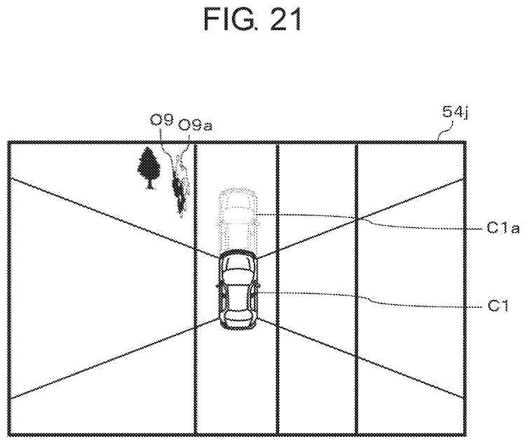

FIG. 21 is a view showing one example of monitoring picture 54j displayed on display 54 of remote control device 50 according to operation example 10. In monitoring picture 54j, both the vehicle C1 in a state in which communication delay is not corrected (that is, the vehicle defined in picture data), and the vehicle C1a in a state in which the communication delay is corrected (the vehicle at the estimated current position) are displayed together. Furthermore, ninth object O9 (bicycle) in a state in which the communication delay is not corrected and ninth object O9a in a state in which the communication delay is corrected are displayed together.

According to operation example 10, at least one of autonomous vehicle 1 and the moving object where the communication delay is corrected are displayed in the monitoring picture, and thereby it is possible to improve accuracy of judgment to restart driving by the monitor.

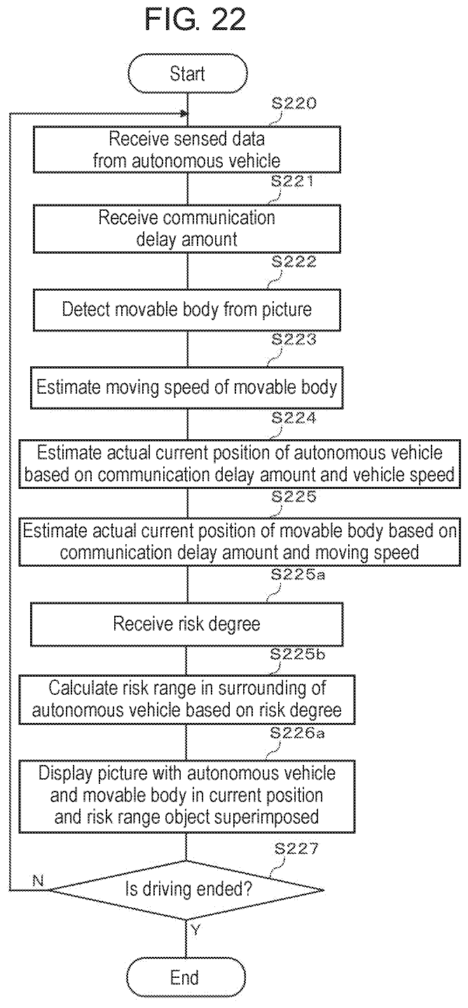

FIG. 22 is a flowchart showing a flow of processing of a displaying method of a monitoring picture in which a communication delay is visualized according to operation example 11. Picture generator 511 of remote control device 50 receives sensed data from autonomous vehicle control device 10 via network 2 (S220). Picture generator 511 receives an amount of a communication delay between autonomous vehicle control device 10 and remote control device 50 from autonomous vehicle control device 10 via network 2 (S221).

Picture analyzer 513 detects a moving object from each frame of the received picture data (S222). Picture analyzer 513 estimates a moving speed of the moving object detected in the frames of the picture data (S223). Picture analyzer 513 estimates an actual current position of autonomous vehicle 1 based on the received communication delay amount and the vehicle speed of autonomous vehicle 1 (S224). Picture analyzer 513 estimates an actual current position of the moving object based on the received communication delay amount and the estimated moving speed of the moving object (S225).

Risk range determiner 514 receives the risk degree of autonomous vehicle control device 10 from autonomous vehicle control device 10 via network 2 (S225a). Risk range determiner 514 determines a risk range in the surrounding of autonomous vehicle 1 based on the received risk degree (S225b).

Picture generator 511 generates a monitoring picture on which autonomous vehicle 1 and the moving object in the estimated current position as well as a risk range object are superimposed (S226a). Processing of the step S220 to step S226a mentioned above are repeatedly carried out (N in S227) until the driving of autonomous vehicle 1 is ended (Y in S227).

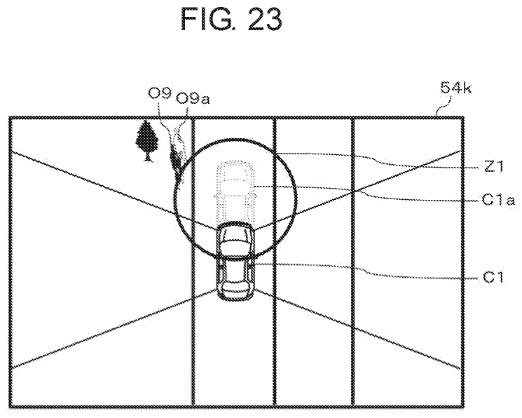

FIG. 23 is a view showing one example of monitoring picture 54k displayed on display 54 of remote control device 50 according to operation example 11. In monitoring picture 54k, a risk range object Z1 around the vehicle C1a in a state in which the communication delay has been corrected is further superimposed and displayed, as compared with monitoring picture 54j shown in FIG. 21. As the displayed position of risk range object Z1, as compared with a position around vehicle C1 in a state in which the communication delay is not corrected, a position around vehicle C1a in a state in which the communication delay is corrected is more desirable because it matches the actual condition. Note here that the size of risk range object Z1 may be dynamically changed in accordance with the risk degree as shown in FIG. 22, or may be fixed.

According to operation example 11, displaying at least one of autonomous vehicle 1 and the moving object where the communication delay is corrected, together with the risk range object in a monitoring picture allows accuracy of judgment to restart driving by the monitor to be further improved.

### Second Exemplary Embodiment

As described above, since wireless communication is carried out between autonomous vehicle 1 and remote control device 50, an image of in-vehicle camera, which is transmitted from autonomous vehicle 1 to remote control device 50, includes a communication delay. Therefore, a monitor on a remote side watches a past image by the communication delay. When the communication delay amount is large, a difference occurs in recognition of the situation by the monitor, and appropriate remote control may not be realized.

The second exemplary embodiment of the present disclosure has been made in view of such circumstance, an object of the second exemplary embodiment is to provide a technology by which a monitor/manipulator on the remote side can understand a situation of autonomous vehicle 1 more accurately. An entire configuration of the remote self-driving system is the same as in the first exemplary embodiment.

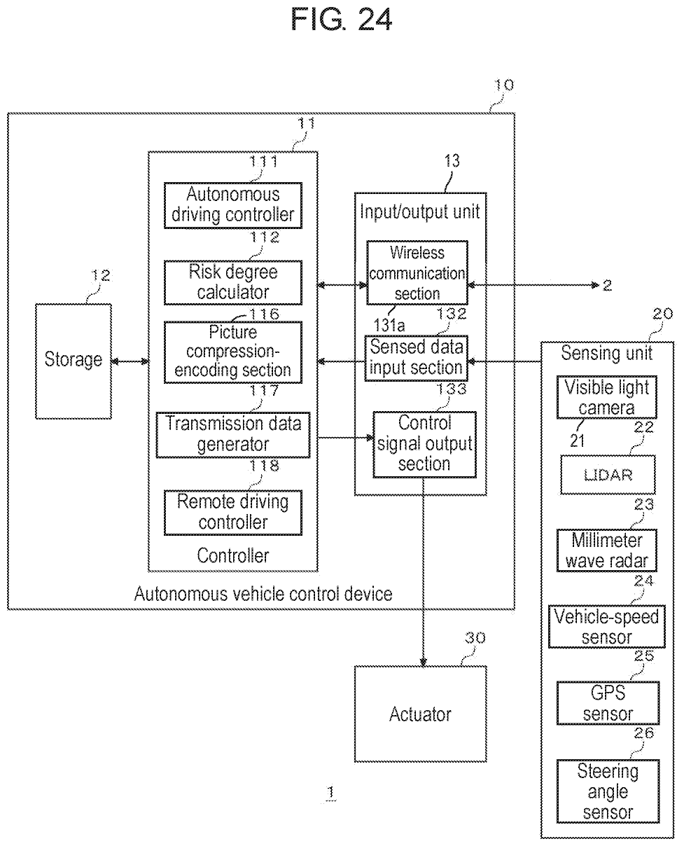

FIG. 24 is a diagram showing a configuration of autonomous vehicle 1 according to the second exemplary embodiment of the present disclosure. Autonomous vehicle 1 includes autonomous vehicle control device 10, sensing unit 20, and actuator 30. Members necessary for a driving operation by a driver, for example, an accelerator pedal, a brake pedal, and a steering wheel, may be placed in a vehicle or may be omitted.

Actuator 30 drives loads such as an engine, a motor, a steering, a brake, and a lamp, for vehicle traveling. Sensing unit 20 includes visible light camera 21, LIDAR (Light Detection and Ranging) 22, millimeter wave radar 23, vehicle-speed sensor 24, GPS sensor 25, and steering angle sensor 26.

At least one visible light camera 21 is placed in a position capable of shooting the front of the vehicle and a surrounding in the traveling direction. Visible light camera 21 capable of shooting the front may be a monocular camera, or a compound-eye camera. Use of the compound-eye camera enables a distance to the object to be estimated based on a parallax image. Furthermore, visible light cameras 21 may be placed in four places, i.e., a front part, a rear part, a left part and a right part of the vehicle. In this case, a front picture, a rear picture, a left picture, and a right picture shot by visible light cameras 21 are combined, and thereby a bird's eye picture/omnidirectional picture can be generated.

Each of visible light cameras 21 includes a solid-state image sensor (for example, CMOS (Complementary Metal Oxide Semiconductor) image sensor, CCD (Charge-Coupled Device) image sensor), and a signal processing circuit, each serving as an imaging circuit. The solid-state image sensor converts light that passes through a lens and is incident thereon into an electric signal. The signal processing circuit performs signal processing such as conversion from an analog signal to a digital signal and noise removal. Signal-processed picture data are output to autonomous vehicle control device 10.

LIDAR 22 radiates a light beam (for example, an infrared laser) into the surrounding of the vehicle, receives the reflected signal thereof, and measures a distance with respect to an object existing in the surrounding, a size of the object, and a composition of the object, based on the received reflected signal. The moving speed of the object can be measured by placing a plurality of LIDARs 22 or mobile LIDAR 22. Furthermore, a three-dimensional modeling picture of the surrounding of the vehicle can be generated.

Millimeter wave radar 23 radiates an electric wave (millimeter wave) into the surrounding of the vehicle, receives the reflected signal thereof, and measures a distance to an object existing in the surrounding based on the received reflected signal. The object in the surrounding of the vehicle can be detected in a wide range by placing a plurality of millimeter wave radars 23. Millimeter wave radar 23 can detect the object existing in more distance, which is difficult to be detected by LIDAR 22.

Vehicle-speed sensor 24 detects a speed of autonomous vehicle 1. GPS sensor 25 detects position information of autonomous vehicle 1. Specifically, GPS sensor 25 receives transmitting time from each of a plurality of GPS satellites, and calculates latitude and longitude of the receiving point based on the respective received transmitting times. Steering angle sensor 26 detects a steering angle of the steered wheel of autonomous vehicle 1.

Autonomous vehicle control device 10 includes controller 11, storage 12 and input/output unit 13. Controller 11 includes autonomous driving controller 111, risk degree calculator 112, picture compression-encoding section 116, transmission data generator 117, and remote driving controller 118. The functions of controller 11 can be implemented by cooperation of a hardware resource and a software resource, or by only a hardware resource. As the hardware resource, a processor, ROM, RAM, and other LSI, can be employed. As the processor, CPU, GPU, DSP, and the like, can be employed. As the software resource, programs such as an operating system and application can be utilized.

Storage 12 includes, for example, HDD, and/or SSD. Storage 12 stores data such as a three-dimensional map necessary for autonomous traveling. Input/output unit 13 includes wireless communication section 131a, sensed data input section 132, and control signal output section 133. Wireless communication section 131a includes an antenna, RF (Radio Frequency) section and a baseband section, and carries out wireless communication with wireless LAN router 2a or base station device 2b. Sensed data input section 132 acquires various sensed data from sensing unit 20, and outputs the sensed data to controller 11. Control signal output section 133 outputs control signals to various actuators 30. The control signals are generated in controller 11 and configured to drive various actuators 30.

Autonomous driving controller 111 allows autonomous vehicle 1 to autonomously travel based on a predetermined self-driving algorithm. Specifically, autonomous driving controller 111 recognizes the situation of the vehicle and around the vehicle based on various types of sensed data sensed by detection unit 20 and various types of information collected from the outside by radio. Autonomous driving controller 111 applies various parameters indicating the recognized situation to the self-driving algorithm so as to determine an action of autonomous vehicle 1. Autonomous driving controller 111 generates various control signals for driving various actuators 30 based on the determined action, and outputs the signals to actuator 30, respectively.

The self-driving algorithm is generated by artificial intelligence (AI) based on deep learning. Various parameters of the self-driving algorithm are initialized to values previously learned by high-specification computer, and updated values are downloaded from the data center on the cloud appropriately.

Risk degree calculator 112 calculates the current risk degree of autonomous vehicle 1 based on various parameters such as LDW (Lane Departure Warning), FCW (Forward collision warning), sudden steering, sudden braking, a time zone, a location, and weather. For example, when any one of events, such as LDW, FCW, sudden steering, and sudden braking occurs, the risk degree is largely increased.

Furthermore, risk degree calculator 112 may calculate a current risk degree of autonomous vehicle 1 based on risk prediction algorithm generated by artificial intelligence based on deep learning. In this case, the risk degree can be calculated with various data sensed by sensing unit 20 taken into account. The risk degree is defined by values in a range from, for example, 0 to 100.

Picture compression-encoding section 116 compresses and encodes picture data acquired from visible light camera 21. For example, picture data are compressed and encoded according to compressing and encoding standard based on MPEG (Motion Picture Experts Group) system. Note here that as preprocess of compressing and encoding, at least one of pixel decimation and frame decimation may be carried out. For example, an image captured at 30 Hz/60 Hz may be converted into 15 Hz/30 Hz image. In this case, although the image quality is degraded, the amount of communication can be reduced.

Transmission data generator 117 generates data to be transmitted to remote control device 50 via wireless communication section 131a. Transmission data generator 117 includes picture data captured by visible light camera 21 and compressed and encoded by picture compression-encoding section 116 into data to be transmitted to remote control device 50. Note here that when four visible light cameras 21 are disposed, picture data of each of four visible light cameras 21 is transmitted by one of four channels, separately. Note here that a method of synthesizing a front picture, a rear picture, a left picture, and a right picture shot by visible light cameras 21 to generate an omnidirectional picture in autonomous vehicle control device 10, compressing and encoding the omnidirectional picture, and transmitting the compressed and encoded picture may be employed.

Furthermore, transmission data generator 117 includes state data including a traveling speed, a steering angle, and a current position of autonomous vehicle control device 10 into data to be transmitted to remote control device 50. In the state data, the risk degree calculated by risk degree calculator 112 is included as necessary. The picture data and the state data may be transmitted in a state in which they are superposed in one channel or may be transmitted in separate channels.

Remote driving controller 118 generates control signals for driving various actuators 30 based on control commands transmitted from remote control device 50, and output them to actuators 30, respectively. Autonomous vehicle 1 according to this exemplary embodiment basically travels in an autonomous mode, but autonomous traveling may become difficult due to deterioration of the road environment or weather conditions. In this case, the mode is switched to the remote operation mode. Furthermore, at the time of restarting driving after an emergency stop, the mode is temporarily switched to the remote operation mode. Furthermore, when autonomous vehicle 1 is a taxi or a bus, the mode is switched to the remote operation mode for addressing passengers who get on and off autonomous vehicle 1.

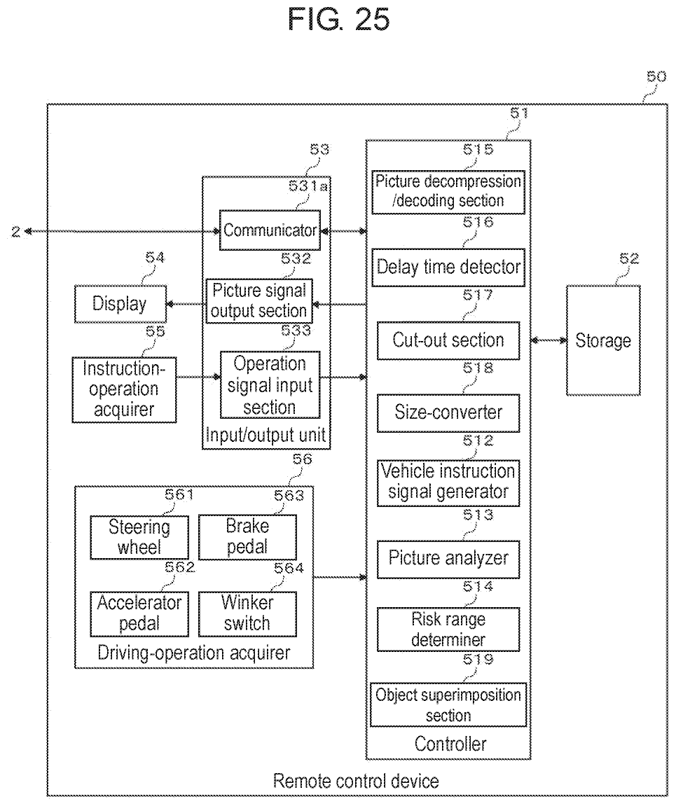

FIG. 25 is a diagram showing a configuration of remote control device 50 according to the second exemplary embodiment of the present disclosure. Remote control device 50 is constructed by at least one server or PC and an operation accepter. Remote control device 50 includes controller 51, storage 52, input/output unit 53, display 54, instruction-operation acquirer 55, and driving-operation acquirer 56. Display 54 includes a liquid crystal display or an organic EL display. Instruction-operation acquirer 55 includes input devices such as a keyboard, a mouse, and a touch panel, and outputs an operation signal generated by an operation of a user to controller 51.

Driving-operation acquirer 56 has a remote operation accepter for manipulation operation, which simulates the operation accepter in the driver's seat of autonomous vehicle 1. Specifically, the operation accepter includes steering wheel 561, accelerator pedal 562, brake pedal 563 and winker switch 564. Further, driving-operation acquirer 56 may include a gear lever and a meter such as a speed meter or a tachometer. Note here that the meter may be displayed in display 54 as a picture. Note here that although not shown in FIG. 25, as audio interface for conversation with the passengers who get on autonomous vehicle 1, driving-operation acquirer 56 may include a microphone and a loudspeaker.

Controller 51 includes picture decompression-decoding section 515, delay time detector 516, cut-out section 517, size-converter 518, vehicle instruction signal generator 512, picture analyzer 513, risk range determiner 514, and object superimposition section 519. The functions of controller 51 can be implemented by cooperation of a hardware resource and a software resource, or by only a hardware resource. As the hardware resource, a processor, ROM, RAM, and other LSI, can be employed. As the processor, CPU, GPU, DSP, and the like, can be employed. As the software resource, programs such as an operating system and application can be utilized.

Storage 52 includes, for example, HDD, and/or SSD. Storage 52 stores data necessary to remote monitoring/remote manipulation of autonomous vehicle 1, for example, a three-dimensional map synchronized to the three-dimensional map stored in storage 12 of autonomous vehicle control device 10. Input/output unit 53 includes communicator 531a, picture signal output section 532, and operation signal input section 533. Communicator 531a includes a LAN connector to be connected to router 2d with wire or without wire. Picture signal output section 532 is an interface to be connected to display 54, and includes, for example, an HDMI (registered trade mark) (High-Definition Multimedia Interface) connector. Picture signal output section 532 outputs an image captured by visible light camera 21 of autonomous vehicle 1 to display 54. Operation signal input section 533 inputs an operation signal, accepted from instruction-operation acquirer 55, into controller 51.

Picture decompression-decoding section 515 decompresses and decodes the compressed and encoded picture data received from autonomous vehicle control device 10 via communicator 531a. Delay time detector 516 detects communication delay time until remote control device 50 receives picture data transmitted from autonomous vehicle control device 10 via network 2. Delay time detector 516 detects the communication delay time based on a difference between transmission time at which autonomous vehicle control device 10 transmits picture data and reception time at which remote control device 50 receives the picture data.

Specifically, the communication delay time is calculated based on the difference between the type stamp of the transmission time included in the picture data and the reception time. In this exemplary embodiment, a first standard processing time and a second processing time are added to the communication delay time so as to obtain final communication delay time. The first standard processing time is for compression-encoding processing by picture compression-encoding section 116 of autonomous vehicle control device 10, and the second standard processing time is for decompression-decoding processing by picture decompression-decoding section 515 of remote control device 50. Note here that when the time for the compression-encoding processing and the time for decompression-decoding processing are negligibly small, the adding processing is not needed.

Cut-out section 517 cuts out a predetermined range of picture from the frame picture included in the image received from autonomous vehicle control device 10. Cut-out section 517 determines the range to be cut out from the frame picture based on the speed and the steering angle of autonomous vehicle 1 received by autonomous vehicle control device 10, and the communication delay time detected by the delay time detector 516.

Specifically, cut-out section 517 estimates a viewpoint corresponding to the current position of autonomous vehicle 1 based on the speed and the steering angle of autonomous vehicle 1, and the communication delay time. That is to say, based on the speed and steering angle of autonomous vehicle 1, cut-out section 517 estimates a movement vector along which autonomous vehicle 1 moves during the communication delay time, and estimates the current position and the direction of autonomous vehicle 1. Cut-out section 517 extracts an estimated picture estimated to be visible from the viewpoint of the estimated current position of autonomous vehicle 1 by cutting out a predetermined range in the frame picture.

Size-converter 518 converts the picture cut out by cut-out section 517 into a picture having a size corresponding to the display size of display 54. In this exemplary embodiment, it is assumed that a front image of autonomous vehicle 1 is displayed on display 54. That is to say, it is assumed that a front image seen from a viewpoint of a driver is displayed supposing that a driver is on autonomous vehicle 1 (hereinafter, referred to as a “virtual viewpoint”). In this case, when autonomous vehicle 1 moves forward, the virtual viewpoint is approaching to the front scene in the frame picture during the communication delay time. Therefore, by cutting out a predetermined range in the frame picture and the enlarging the image of the cut out range, an estimated picture estimated to be visible from the virtual viewpoint of the current position can be generated.

Size-converter 518 can enlarge the size of the picture cut out by pixel interpolation of the picture cut out by cut-out section 517. As the pixel interpolation, for example, a bilinear method, a bicubic method, a Lanczos method, and the like, can be used.

Vehicle instruction signal generator 512 generates a control command for remote operating/remote manipulating autonomous vehicle 1 based on the operation/manipulation given to instruction-operation acquirer 55 or driving-operation acquirer 56. Communicator 531a transmits the generated control command to autonomous vehicle control device 10 via network 2.

Picture analyzer 513 detects a moving object from the inside of each frame picture included in the image received from autonomous vehicle control device 10. Picture analyzer 513 searches the frame pictures using an identifier of a moving object registered in advance so as to be recognized as an obstacle, and detects the moving object. Picture analyzer 513 estimates the movement vector of the moving object detected in the frame pictures. Specifically, picture analyzer 513 detects a difference between a position of the moving object detected in the current frame picture and a position of the moving object detected in the past frame picture so as to detect the movement vector of the moving object.

Risk range determiner 514 determines a risk range in the surrounding of autonomous vehicle 1 based on the risk degree received from autonomous vehicle control device 10 via network 2. Risk range determiner 514 increases an area of the risk range as the risk degree is higher. Furthermore, when the direction of the movement vector of the moving object detected by picture analyzer 513 is a direction approaching to autonomous vehicle 1, risk range determiner 514 increases the risk range. At this time, the higher the speed of the movement vector is, the wider risk range determiner 514 makes the area of the risk range.

Object superimposition section 519 superimposes a risk range object corresponding to the risk range determined by risk range determiner 514 onto a frame picture included in the image to be displayed on display 54. Picture signal output section 532 outputs a frame picture, on which the risk range object is superimposed, to display 54.

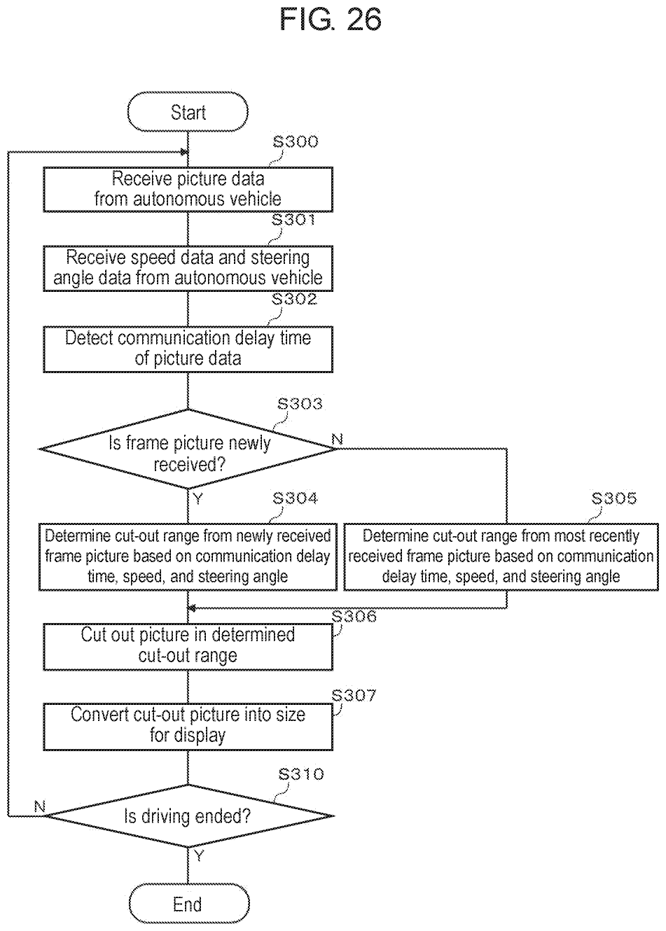

FIG. 26 is a flowchart showing a flow of a basic operation when remote control device 50 displays an image received from autonomous vehicle 1 in accordance with the second exemplary embodiment of the present disclosure. Communicator 531a of remote control device 50 receives picture data of the image captured by visible light camera 21 from autonomous vehicle 1 via network 2 (S300). Communicator 531a receives speed data and steering angle data of autonomous vehicle 1 from autonomous vehicle 1 via network 2 (S301). Delay time detector 516 detects a communication delay time of the received picture data (S302).

In the case of the head frame picture (N of S 303), cut-out section 517 determines a cut-out range from the head frame picture based on the communication delay time, the speed, and the steering angle (S305). When the frame picture is newly received (Y in S303), cut-out section 517 determines a cut-out range from the newly received frame picture based on the communication delay time, the speed, and the steering angle (S304). Cut-out section 517 cuts out a picture of the determined cut-out range from the frame picture (S306). Size-converter 518 converts the cut-out picture into a picture having size for display (S307). Picture signal output section 532 outputs the frame picture that has been converted into the size for display on display 54.

In this exemplary embodiment, a frame rate of an image received from autonomous vehicle 1 is set to be the same as a frame rate of an image to be displayed on display 54. When a next frame picture is not received from autonomous vehicle 1 at the timing of generating the next frame picture for display, (N in S303), the next frame picture for display is generated from the frame picture received most recently from autonomous vehicle 1 (S305, S306, and S307). Note here that next frame picture for display may be generated from the current frame picture for display. Processing from the step S300 to step S307 mentioned above is repeatedly executed (N in S310) until the driving of autonomous vehicle 1 is ended (Y in S310).

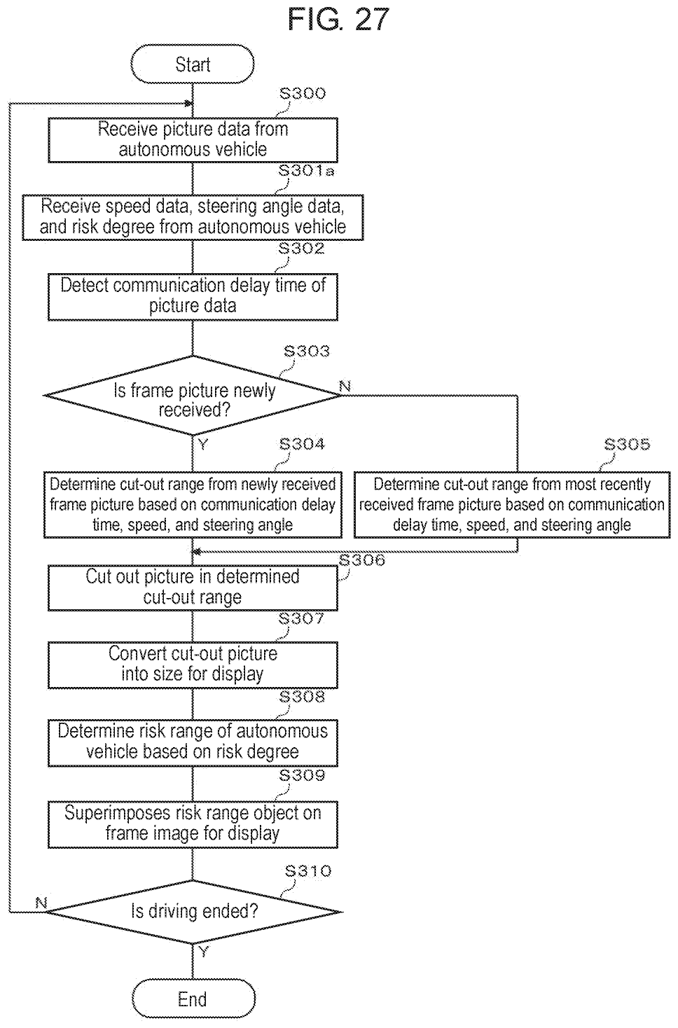

FIG. 27 is a flowchart showing a flow of a development processing when remote control device 50 displays an image received from autonomous vehicle 1 in accordance with the second exemplary embodiment of the present disclosure. Herein, differences from the basic processing shown in FIG. 26 are described. Communicator 531a receives the risk degree in addition to the speed data and the steering angle data of autonomous vehicle 1 from autonomous vehicle 1 via network 2 (S301a).

Risk range determiner 514 determines the risk range in the surrounding of autonomous vehicle 1 based on the risk degree received from autonomous vehicle control device 10 (S308). Note here that when a predetermined moving object (for example, a pedestrian or a bicycle) is detected in the frame picture, and when the moving object moves toward autonomous vehicle 1, risk range determiner 514 enlarges the risk range at least in the direction in which the moving object is present. Object superimposition section 519 superimposes the risk range object corresponding to the determined risk range into the frame picture to be displayed in display 54 (S309). Picture signal output section 532 outputs the frame picture, in which the risk range object is superimposed, to display 54. The other processing are the same as those shown in FIG. 26.

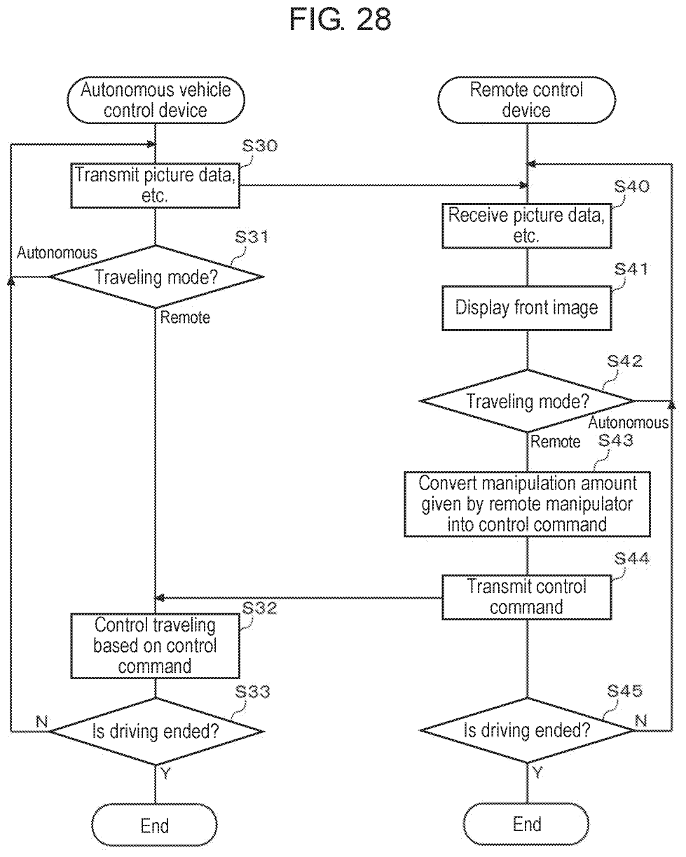

FIG. 28 is a flowchart showing a basic operation of a remote self-driving system according to the second exemplary embodiment of the present disclosure. Wireless communication section 131a of autonomous vehicle control device 10 transmits picture data of an image captured by visible light camera 21 and state data of autonomous vehicle 1 to remote control device 50 via network 2 (S30). Communicator 531a of remote control device 50 receives the picture data and the state data (S40). Display 54 displays a front image of autonomous vehicle 1 generated based on the picture data and the state data (S41).

When the traveling mode of autonomous vehicle 1 is an autonomous mode (Autonomous in S31 and S42), autonomous driving controller 111 of autonomous vehicle control device 10 allows autonomous vehicle 1 to autonomously travel. Display 54 of remote control device 50 continues to display the front image of autonomous vehicle 1 (S40, S41).

When the traveling mode of autonomous vehicle 1 is a remote control mode (Remote in S31 and S42), vehicle instruction signal generator 512 of remote control device 50 converts a manipulation amount (operation amount) given to driving-operation acquirer 56 by a remote manipulator into a control command (S43). Communicator 531a transmits the control command to autonomous vehicle control device 10 via network 2 (S44). Remote driving controller 118 of autonomous vehicle control device 10 controls traveling of autonomous vehicle 1 based on the control command received from remote control device 50 (S32). The above-mentioned processing of step S30 to step S32 and processing from step S40 to step S44 are repeatedly carried out (N in S33 and N in S45) until the driving is ended (Y in S33 and Y in S45).

Hereinafter, a specific example of cutting out a picture of a predetermined cut-out range from the frame picture is described. In the following specific example, it is presumed that an image is captured by visible light camera 21 having a wide-angle lens, which is placed in the front of autonomous vehicle 1. The frame picture captured by visible light camera 21 having a wide-angle lens has a rectangular shape having a long aspect ratio in the horizontal direction.

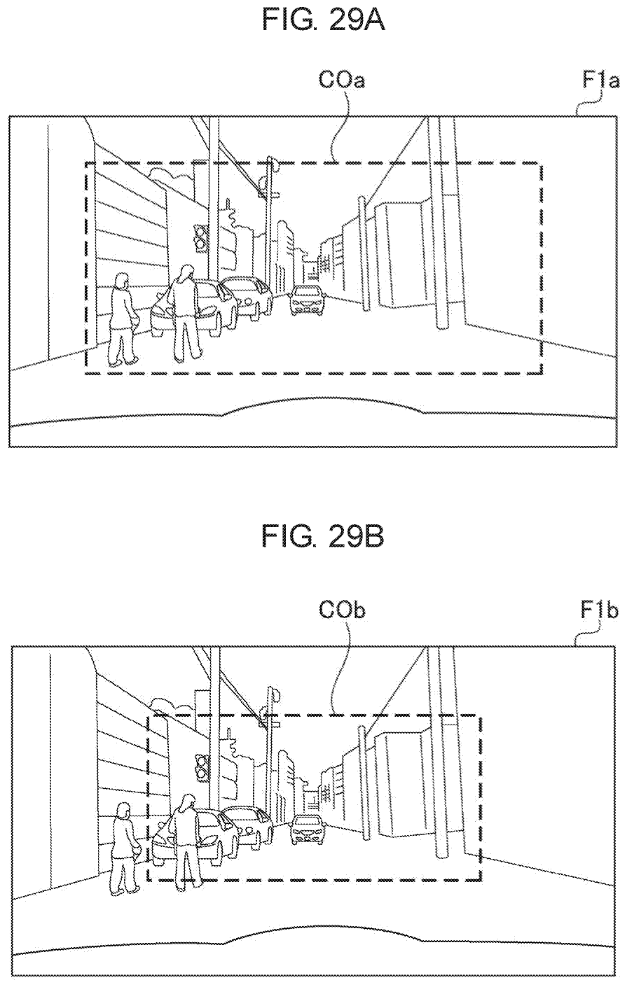

FIGS. 29A and 29B are views respectively showing examples of cut-out ranges cut out when autonomous vehicle 1 travels straight. FIG. 29A shows first frame picture F1a included in the image received from autonomous vehicle 1, and FIG. 29B shows second frame picture F1b included in the image received from autonomous vehicle 1.

Firstly, a case where autonomous vehicle 1 travels straight at a constant speed, and the communication delay time of second frame picture F1b is longer than that of first frame picture F1a is considered. In this case, the cut-out range COb in second frame picture F1b is narrower than cut-out range COa in first frame picture F1a. It means that as the communication delay time is longer, a virtual viewpoint advances. When the image of narrow cut-out range COb is enlarged and displayed, a picture corresponding to the movement of the virtual viewpoint can be displayed.

Note here that first frame picture F1a may be the same as second frame picture F1b. When the communication delay is suddenly increased, and the increase of the communication delay can be recognized but next frame picture is not transmitted from autonomous vehicle 1, the cut-out range in the frame picture that has already been transmitted is narrowed so as to correspond the advance of the virtual viewpoint.

Next, a case is considered where the communication delay time of first frame picture F1a is the same as the communication delay time of second frame picture F1b, and the speed of autonomous vehicle 1 at the time of capturing second frame picture F1b is faster than the speed of autonomous vehicle 1 at the time of capturing first frame picture F1a. Also in this case, the cut-out range COb in second frame picture F1b is narrower than cut-out range COa in first frame picture F1a. It means that as the speed of autonomous vehicle 1 is faster, virtual viewpoint advances. The picture of narrower cut-out range COb is enlarged and displayed, and thereby a picture corresponding to the movement of the virtual viewpoint can be displayed. Note here that a shape of first frame picture F1a is similar to a shape of second frame picture F1b.

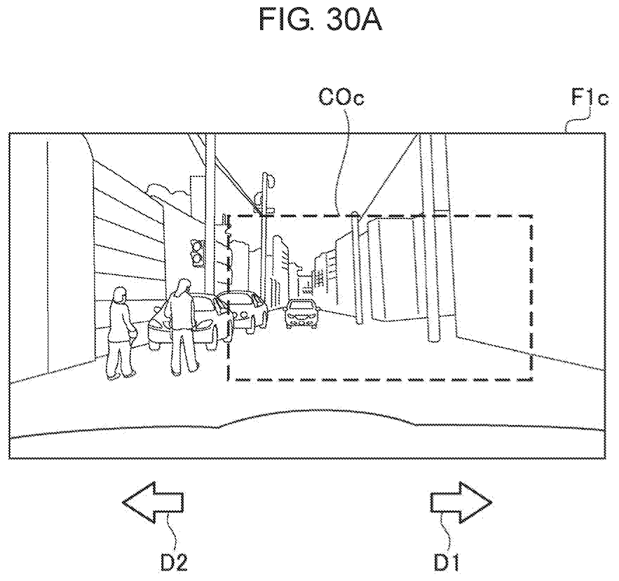

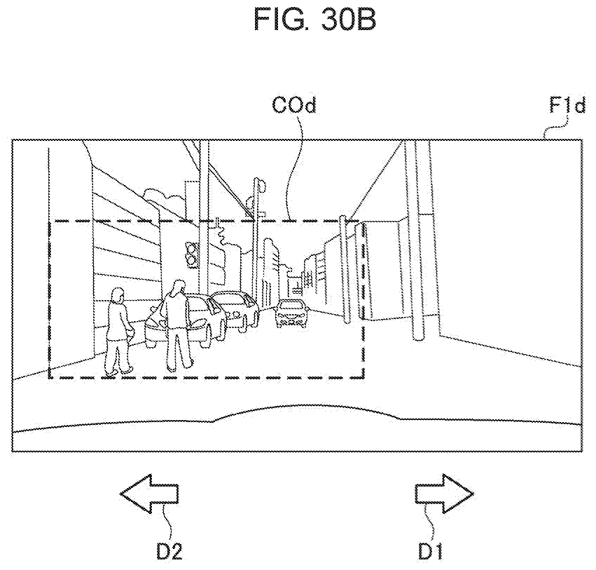

FIG. 30A and FIG. 30B are views showing examples of cut-out ranges cut out when an autonomous vehicle travels on a curve. FIG. 30A shows third frame picture F1c included in the image received from autonomous vehicle 1, and FIG. 30B shows fourth frame picture F1d included in the image received from autonomous vehicle 1. Cut-out range COb of autonomous vehicle 1 immediately before curve is a state of FIG. 29B.

Autonomous vehicle 1 travels on the curve at a constant speed, and the communication delay time of third frame picture F1c is the same as the communication delay time of fourth frame picture F1d. Remote control device 50 receives a steering angle from autonomous vehicle 1. The steering angle is expressed by the first direction (right direction, clockwise direction) D1 and the angle (positive value), or the second direction D2 (left direction, anti-clockwise direction) and the angle thereof (positive value) with respect to the direction in which autonomous vehicle 1 travels straight. Note here that the first direction may be expressed as the positive value, and the second direction may be expressed as a negative value.

The steering angle of autonomous vehicle 1 when third frame picture F1c is captured is a first angle in first direction D1. In this case, a picture of cut-out range COc is displaced to first direction D1 with respect to cut-out range COb of FIG. 29B, is enlarged, and is displayed in display 54. Thus, a picture corresponding to the rotation movement to first direction D1 of virtual viewpoint can be displayed.

The steering angle of autonomous vehicle 1 when fourth frame picture F1d is captured is a second angle in second direction D2. In this case, a picture of cut-out range COd is displaced to second direction D2 with respect to cut-out range COb of FIG. 29B, is enlarged, and displayed in display 54. Thus, a picture corresponding to the rotation movement to second direction D2 of virtual viewpoint can be displayed.

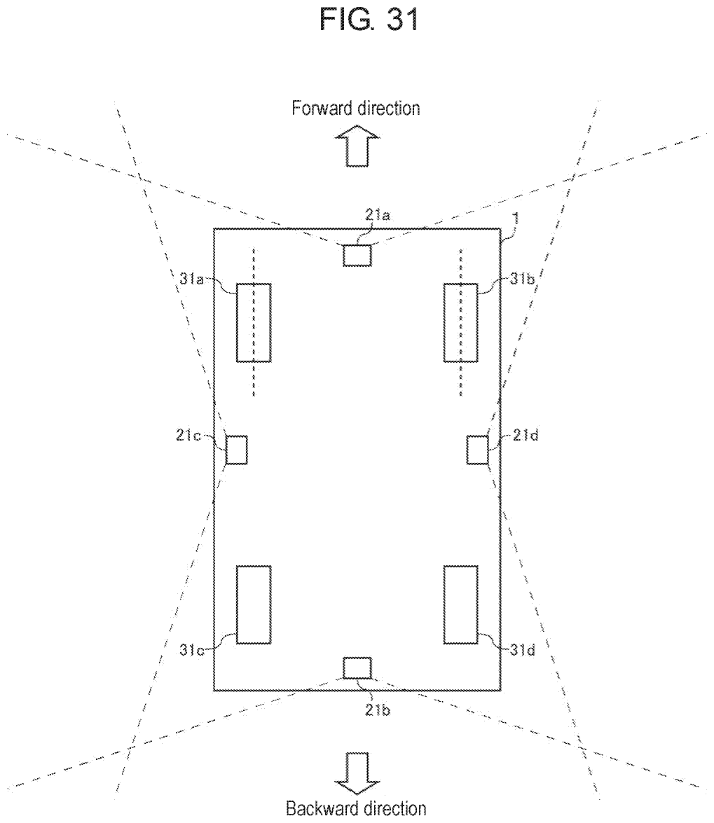

FIG. 31 is a view showing a state of steered wheels when autonomous vehicle 1 travels straight. In the autonomous vehicle 1 shown in FIG. 31, among left front wheel 31a, right front wheel 31b, left rear wheel 31c, and right rear wheel 31d, left front wheel 31a and right front wheel 31b are used as steered wheels for steering the vehicle. Furthermore, four visible light cameras 21a to 21d are placed in the front, the rear, the right, and the left of the vehicle, an image captured by visible light camera 21a placed in the front is transmitted to remote control device 50.

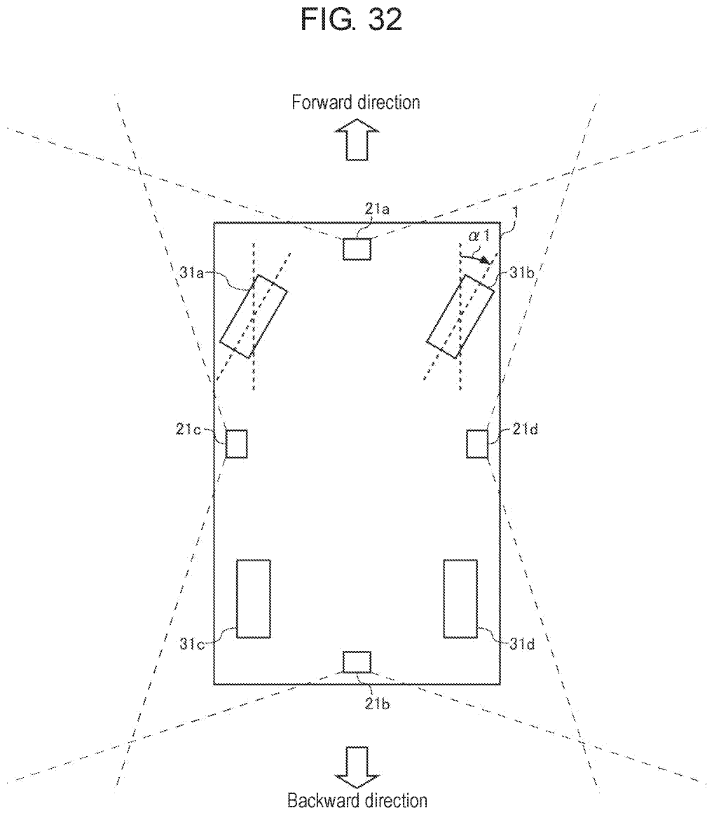

FIG. 32 is a view showing a state of the front (steered) wheels when autonomous vehicle 1 travels on a curve to right. The front wheels are turned by first angle α1 in the first direction (right direction, clockwise direction) with respect to the direction in which autonomous vehicle 1 travels straight. The data of the direction and angle are transmitted to remote control device 50 as a steering angle data.

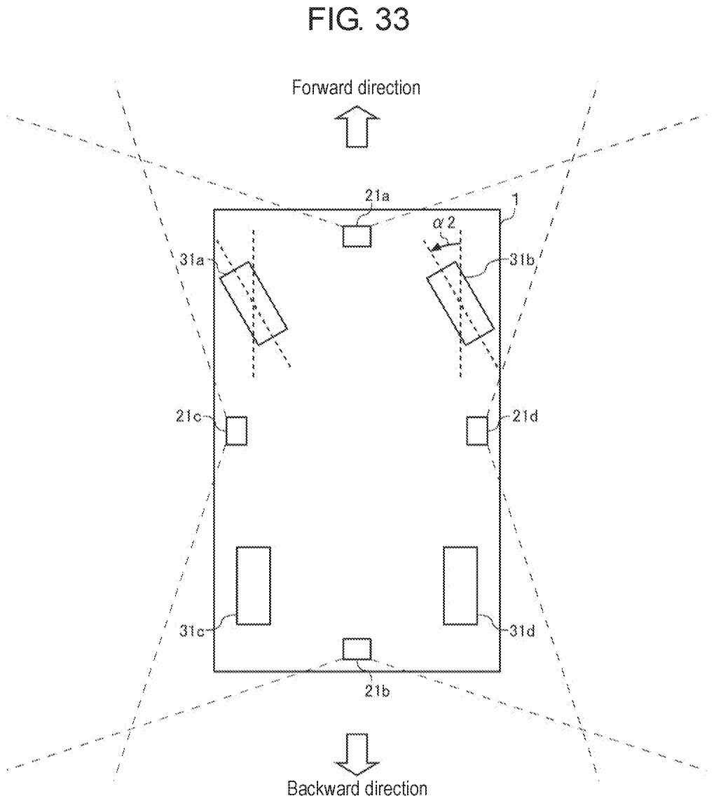

FIG. 33 is a view showing a state of the front (steered) wheels when an autonomous vehicle 1 travels on a curve to left. The front wheels are turned by second angle α2 in the second direction (left direction, anti-clockwise direction) with respect to the direction in which autonomous vehicle 1 travels straight. The data of the direction and angle are transmitted to remote control device 50 as a steering angle data.

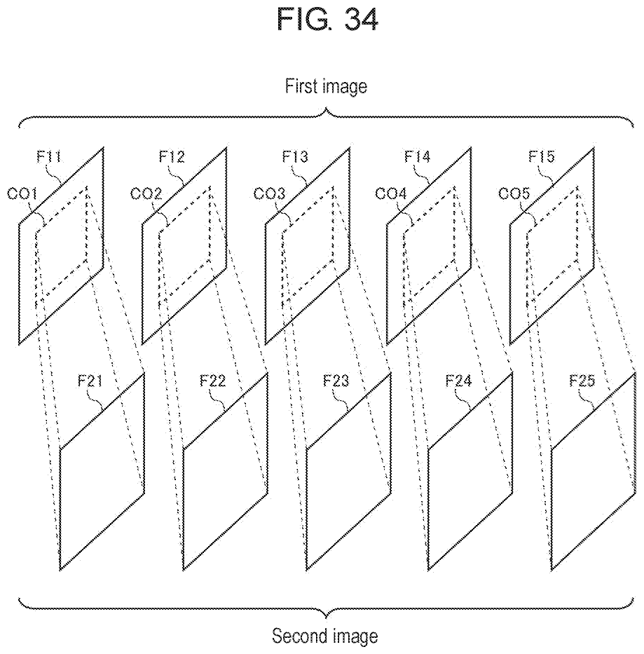

FIG. 34 shows an example of a first relation between a frame picture of a first image captured by visible light camera 21 of autonomous vehicle 1 and a frame picture of a second image displayed on display 54 of remote control device 50. The example of the first relation is an example in which the communication delay of the frame picture of the first image transmitted from autonomous vehicle 1 is constant. In this case, remote control device 50 enlarges a picture of cut-out range CO1 in the first frame picture F11 of the first image to generate first frame picture F21 of the second image. Hereinafter, similarly, in the relation of one on one, pictures of cut-out ranges CO2 to CO5 respectively cut out from the second to fifth frame pictures F12 to F15 of the first image are enlarged to generate the second to the fifth frame pictures F22 to 25 of the second image.

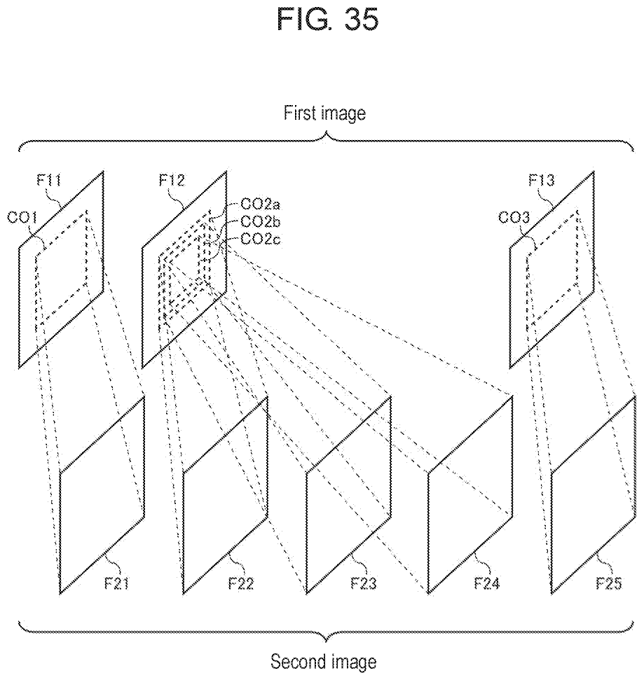

FIG. 35 shows an example of a second relation between a frame picture of a first image captured by visible light camera 21 of autonomous vehicle 1 and a frame picture of a second image displayed on display 54 of remote control device 50. The example of the second relation is an example in which the communication delay of the first frame picture transmitted from autonomous vehicle 1 is not constant. The example shown in FIG. 35 shows a case where the communication delay is elongated between second frame picture F12 and third frame picture F13 of the first image. In this case, remote control device 50 generates third frame picture F23 and fourth frame picture F24 of the second image from the already received second frame picture F12 without waiting for reception of third frame picture F13 of the first image.

The longer the time interval with respect to the second frame picture F12 of the first image becomes, the narrower the cut-out range CO2 of second frame picture F12 becomes. Third frame picture F23 of second image is based on cut-out range CO2b, and second frame picture F22 of the second image is based on cut-out range CO2a. Cut-out range CO2b becomes narrower than cut-out range CO2a. Fourth frame picture F24 of the second image is based on cut-out range CO2c, and third frame picture F23 of second image is based on cut-out range CO2b. Cut-out range CO2c becomes narrower than cut-out range CO2b.

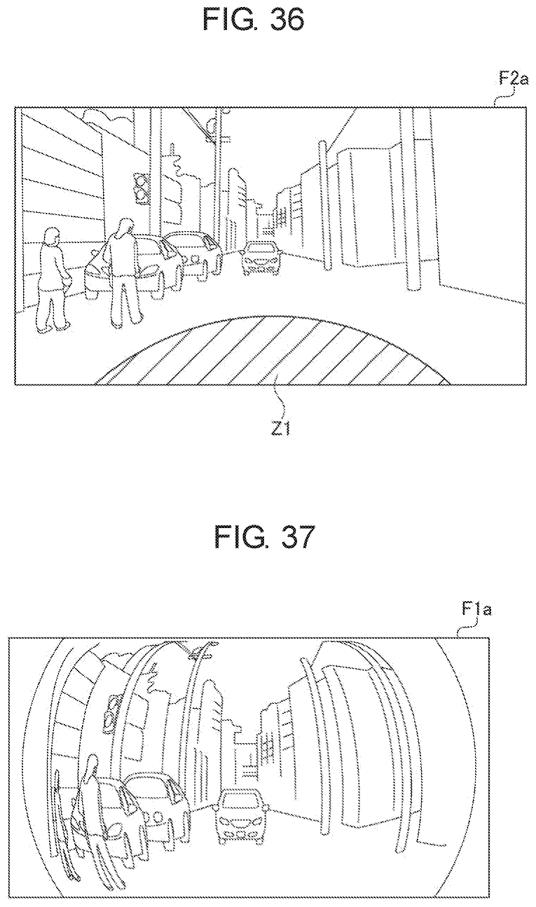

FIG. 36 is a view showing one example of frame picture F2a displayed on display 54 of remote control device 50. Frame picture F2a shown in FIG. 36 a picture generated by enlarging cut-out range COa in first frame picture F1a shown in FIG. 29A, and superimposing risk range object Z1. The remote manipulator of remote monitoring center 5 can intuitively understand the risk degree of autonomous vehicle 1, based on the size of risk range object Z1.

FIG. 37 is a view showing one example of a frame picture captured by visible light camera 21 having a fish-eye lens. The picture captured by visible light camera 21 having the fish-eye lens becomes basically a perfect circular-shaped picture. When the perfect circular-shaped picture is assigned to a rectangular frame region, frame picture F1a having a picture region having a rectangular shape with round corners is obtained. Meanwhile, when pictures captured by four visible light cameras 21a to 21d are synthesized to generate an omnidirectional picture, similarly, a frame picture having a picture region having a rectangular shape with round corners is obtained.

When converting the picture cut out by cut-out section 517 into an image of a display size, size-converter 518 of remote control device 50 performs coordinate conversion based on a distortion parameter set in accordance with the viewing angle of the fish-eye lens. Size-converter 518 interpolates pixels estimated from surrounding pixels into blank pixels in the image after distortion is corrected by the coordinate conversion.

Hereinafter, another specific example is described in which an image in a predetermined cut-out range is cut out from the inside of a frame picture. The following specific example is an example in which autonomous vehicle 1 turns right at the intersection.

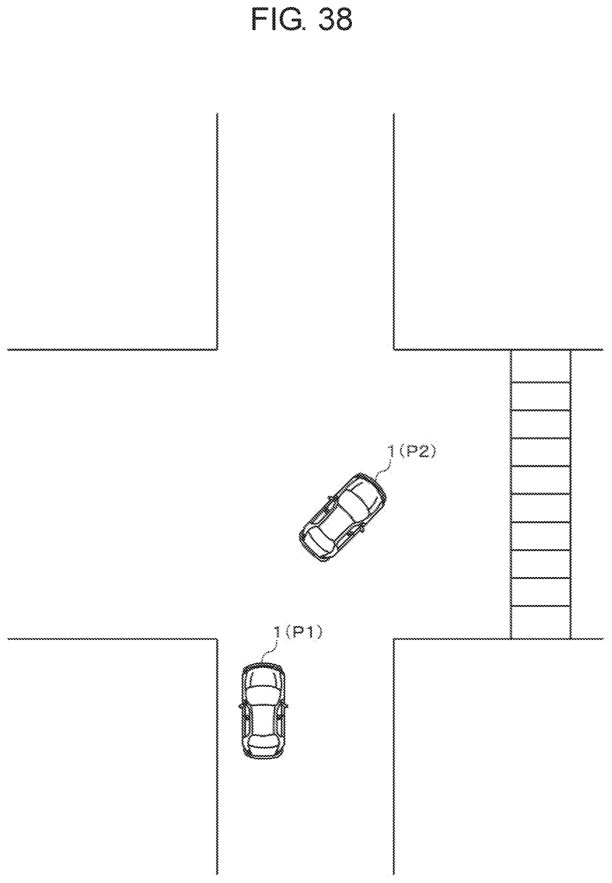

FIG. 38 is a bird's eye view of an intersection where autonomous vehicle 1 is present looked down from the above. Autonomous vehicle 1 at first point P1 shows a state when it travels straight before it starts to turn right, and autonomous vehicle 1 at second point P2 shows a state during turning right.

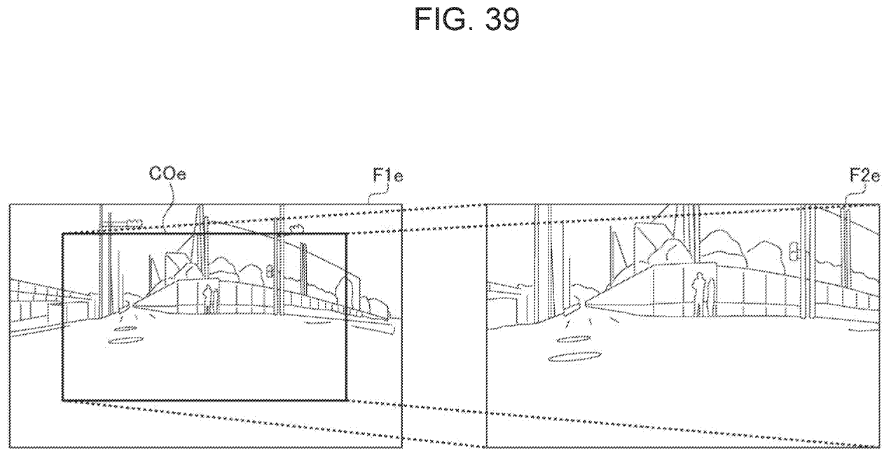

FIG. 39 is a view showing a frame picture captured when autonomous vehicle 1 is positioned at first point P1 in FIG. 38. Frame picture F1e on the left in FIG. 39 is a frame picture captured by visible light camera 21 of autonomous vehicle 1 positioned at first point P1. Since autonomous vehicle 1 is traveling straight, cut-out range COe in frame picture F1e is set in the center of frame picture F1e. Remote control device 50 generates and displays frame picture F2e for display by enlarging the picture of cut-out range COe.

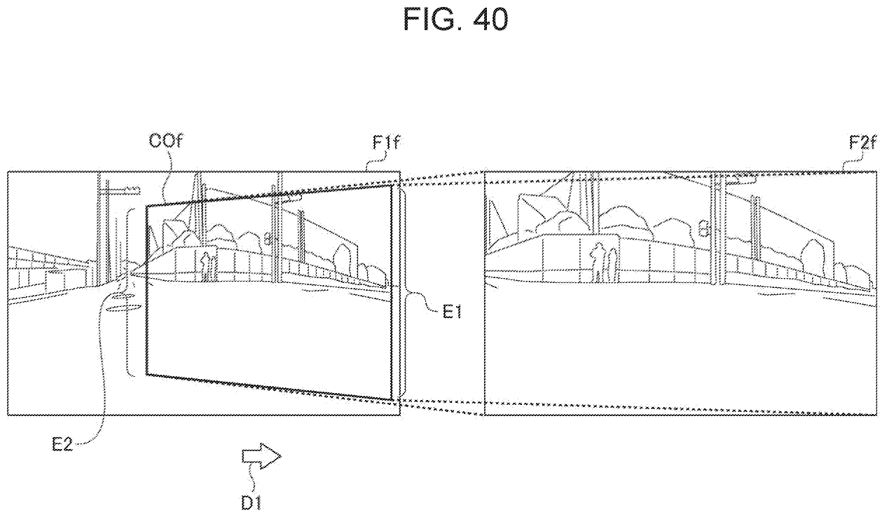

FIG. 40 is a view showing a frame picture captured when autonomous vehicle 1 is positioned at second point P2 in FIG. 38. Frame picture F1f on the left in FIG. 40 is a frame picture captured by visible light camera 21 of autonomous vehicle 1 positioned at second point P2. Since autonomous vehicle 1 is turning right, cut-out range COf in frame picture F1f is set at the position displaced to right from the center of frame picture F1e. Cut-out range COf is set in a trapezoid shape of which left side is shorter than the right side. As the first angle α1 of the front (steered) wheels is larger, the left side is further shorter than the right side in the trapezoid shape. Of cut-out range COf, a width perpendicular to first direction D1 at end portion E1 in first direction D1 is wider than a width perpendicular to first direction D1 at end portion E2 in a direction opposite to the first direction D1. Remote control device 50 corrects the trapezoid distortion when remote control device 50 generates frame picture F2f for display by enlarging a picture of cut-out range COf.

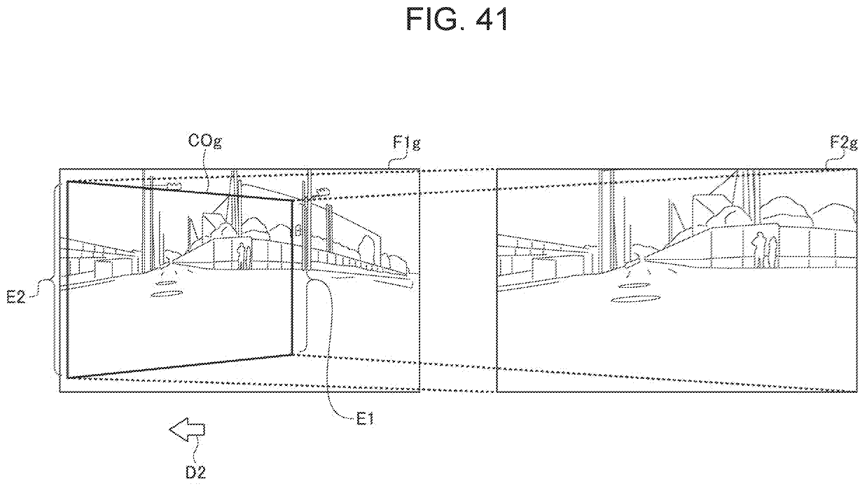

FIG. 41 is a view showing a frame picture captured immediately after autonomous vehicle 1 starts to turn left from first point P1 of FIG. 38. Frame picture F1g on the left in FIG. 41 is a frame picture captured by visible light camera 21 of autonomous vehicle 1 immediately after autonomous vehicle 1 starts to turn left from first point P1. Since autonomous vehicle 1 is turning left, cut-out range COg in frame picture F1g is set at the position displaced to left from the center of frame picture F1g. Cut-out range COg is set in a trapezoid shape of which the right side is shorter than the left side. As the second angle α2 of the front (steered) wheels is larger, the right side is further shorter than the left side in the trapezoid shape. Of cut-out range COg, a width perpendicular to second direction D2 at end portion E2 in second direction D2 is wider than a width perpendicular to second direction D2 at end portion E2 in a direction opposite to the second direction D2. Remote control device 50 corrects the trapezoid distortion when frame picture F2g for display is generated by enlarging a picture of cut-out range COg.

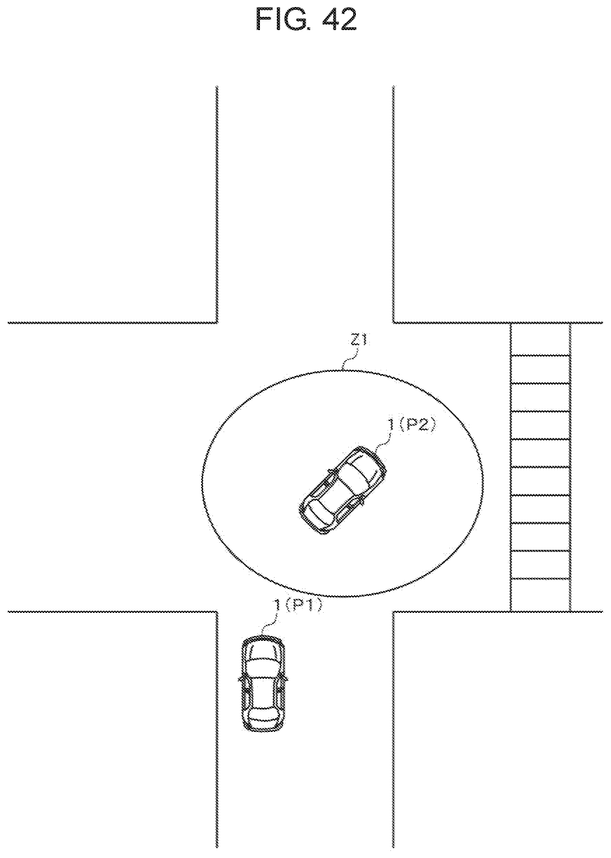

FIG. 42 is a bird's eye view of an intersection on which autonomous vehicle 1 is present, and a risk range object is superimposed in the view. Autonomous vehicle 1 at first point P1 is in a state of traveling straight before starting to turn right, and autonomous vehicle 1 at second point P2 is in a state during turning right. In FIG. 42, risk range object Z1 is superimposed onto the surrounding of autonomous vehicle 1 at second point P2.

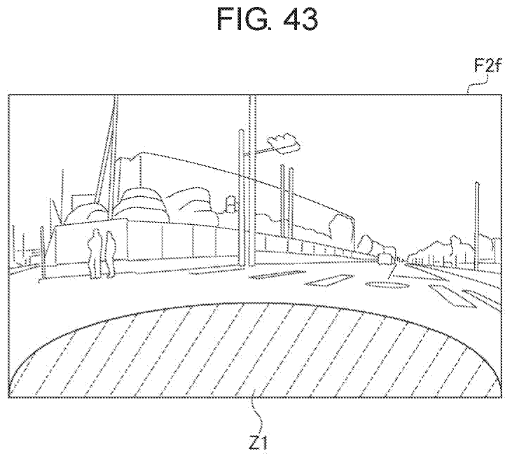

FIG. 43 is a view showing a frame picture for display, generated from a cut-out range in a frame picture captured by visible light camera 21 of autonomous vehicle 1 positioned at second point P2. Frame picture F2f shown in FIG. 43 corresponds to a picture in which risk range object Z1 is superimposed onto frame picture F2f at the right side of FIG. 40. Risk range object Z1 may be drawn as a colored transparent object or a colored filled object.

As described above, according to the second exemplary embodiment, an image received from autonomous vehicle 1 is converted into an image in which a position of a virtual viewpoint has been corrected based on the communication delay time, the speed and the steering angle of autonomous vehicle 1, and the converted image is displayed. Thus, a remote monitor/manipulator of remote monitoring center 5 can understand a current situation of autonomous vehicle 1 more accurately. Therefore, the remote manipulator can carry out remote manipulation in the sense of driving the same as usual.

Steering wheel 561 and accelerator pedal 562 of remote control device 50 are designed such that the movement of steering wheel 561 and accelerator pedal 562 becomes heavier when the remote manipulator manipulates with an amount exceeding the manipulatable range that is determined in accordance with the current situation of autonomous vehicle 1.

Furthermore, when the manipulation instruction given by the remote manipulator includes a high degree of risk in accordance with the current situation of autonomous vehicle 1, a mechanism in which autonomous vehicle 1 is autonomously decelerated or stops is introduced. On the contrary, according to the exemplary embodiment, since the discrepancy between situation of the surrounding of autonomous vehicle 1, which a remote manipulator visually recognizes, and the actual situation of the surrounding of autonomous vehicle 1, is very small, the remote manipulator can carry out a remote manipulation without activating the above-mentioned safety specification.

Furthermore, superimposing the risk range object on the image displayed on the image displayed on display 54 allows the remote manipulator to be alerted in response to the risk degree. When a moving object such as a pedestrian is moving in a direction different from that of autonomous vehicle 1, the position of the moving object in the image displayed on display 54 is different from the actual position of the moving object. In particular, when there is a moving object moving toward autonomous vehicle 1, the remote manipulator can be alerted by enlarging the area of the risk range object.

In the above, the present disclosure is described based on the exemplary embodiments. The exemplary embodiments are examples, and a person skilled in the art would understand that various modified examples combining the component elements or treatment processing can be made and that such modified examples are in the scope of the present disclosure.

In the above-mentioned operation examples 8, 9, and 11, a risk range object is displayed in the monitoring picture. However, instead of the risk range object, a safety range object may be displayed. In this case, a safety range determiner (not shown) makes the safety range larger as the communication delay amount is smaller or the risk degree is smaller. The safety range has an opposite relation to the above-described risk range.

Furthermore, in the first exemplary embodiment, as examples of the sensors for sensing the situation around the vehicle, visible light camera 21, LIDAR 22, and millimeter wave radar 23 are described. In this regard, the other sensors such as an infrared camera and a sonar may further be used in combination.

The above-described second exemplary embodiment describes an example in which the steering angle of autonomous vehicle 1 is received from autonomous vehicle 1. In this regard, in a state in which remote manipulation is being carried out and in which the communication delay time between remote control device 50 and autonomous vehicle 1 is short and stable, the rotation angle of steering wheel 561 of remote control device 50 may be used as the steering angle of autonomous vehicle 1 as it is. Since the control command transmitted from remote control device 50 to autonomous vehicle 1 has small data amount, if the communication line is stable, time from the rotation of steering wheel 561 to actual rotation of the front (steered) wheels of autonomous vehicle 1 is negligible. The data amount of the control command transmitted from remote control device 50 is not as large as that of an image, thus, both the compression-encoding processing and the decompression-decoding processing are not necessary.

Note here that the above-described second exemplary embodiment describes an example in which the movement vector of the moving object is detected and the area of risk range object Z1 is changed. In this regard, in the frame picture to be displayed in display 54, the position of the moving object may be corrected on the picture based on a movement vector of a moving view point of autonomous vehicle 1 and a movement vector of the moving object.

Note here that the exemplary embodiments may be specified by the following items.

[Item 1-1]

An autonomous vehicle control device (10) includes a sensed data input section (132), and a communication section (131). The sensed data input section (132) acquires sensed data indicating a situation around an autonomous vehicle (1) from a sensing device (20) installed in the autonomous vehicle (1). The communication section (131) transmits the sensed data acquired by the sensed data input section (132) to a remote control device (50) that monitors the autonomous vehicle (1) via a network (2). Furthermore, the communication section (131) transmits sensed data whose data amount is changed in accordance with a predetermined condition to the remote control device (50).

This can optimize the amount of data to be transmitted to the remote control device (50) in accordance with the condition.

[Item 1-2]

In the autonomous vehicle control device (10) described in item 1-1, the communication section (131) may transmit sensed data whose data amount is changed in response to the risk degree of the autonomous vehicle (1) to the remote control device (50).

Thus, the amount of data to be transmitted to the remote control device (50) can be reduced while safety is ensured.

[Item 1-3]

In the autonomous vehicle control device (10) described in item 1-2, the sensing device (20) may include an image pickup device (21). Furthermore, the communication section (131) may transmit picture data whose picture quality of picture data acquired from the image pickup device (21) is adjusted in accordance with the risk degree of the autonomous vehicle (1), to the remote control device (50).

Thus, the amount of data to be transmitted to the remote control device (50) can be reduced while safety is ensured.

[Item 1-4]

In the autonomous vehicle control device (10) described in item 1-2 or 1-3, the autonomous vehicle (1) may be provided with a plurality of different types of sensing devices (20). Furthermore, the communication section (131) may transmit at least one type of sensed data selected from the plurality of sensed data acquired respectively from the plurality of sensing devices (20) to the remote control device (50) in accordance with the risk degree of the autonomous vehicle (1).

Thus, the amount of data to be transmitted to the remote control device (50) can be reduced while safety is ensured.

[Item 1-5]

In the autonomous vehicle control device (10) described in item 1-1, the communication section (131) may receive, via the network (2) from the remote control device (50), a signal instructing to improve the quality of the sensed data transmitted to the remote control device (50). Furthermore, the communication section (131) may transmit sensed data whose data amount is increased in response to the signal instructing to improve the quality, to the remote control device (50).

This can improve convenience for a monitor who carries out remote monitoring using the remote control device (50).

[Item 1-6]

In the autonomous vehicle control device (10) described in item 1-1, the communication section (131) may transmit sensed data of which a data amount is larger during stopping because autonomous traveling is impossible than during traveling of the autonomous vehicle (1), to the remote control device (50).

This can improve accuracy of judgment to restart driving by a monitor who carries out remote monitoring using the remote control device (50).

[Item 1-7]

An autonomous vehicle control device (10) includes a sensed data input section (132), and a communication section (131). The sensed data input section (132) acquires sensed data indicating a situation around an autonomous vehicle (1) from a sensing device (20) installed in the autonomous vehicle (1). The communication section (131) transmits the sensed data acquired by the sensed data input section (132) to a remote control device (50) that monitors the autonomous vehicle (1) via a network (2). Furthermore, the communication section (131) transmits the sensed data to the remote control device (50) by a communication system selected from a plurality of communication systems in accordance with a predetermined condition.

This can optimize the communication system in accordance with condition.

[Item 1-8]

A self-driving controlling method has a step of acquiring sensed data indicating a situation around an autonomous vehicle (1) from a sensing device (20) installed in the autonomous vehicle (1). Furthermore, the self-driving controlling method has a step of transmitting the acquired sensed data to a remote control device (50) that monitors the autonomous vehicle (1) via a network (2). In addition, the self-driving controlling method has a step of transmitting the sensed data whose data amount is changed in accordance with a predetermined condition to the remote control device (50).

This can optimize the amount of data to be transmitted to the remote control device (50) in accordance with the condition.

[Item 1-9]

A self-driving controlling method has a step of acquiring sensed data indicating a situation around an autonomous vehicle (1) from a sensing device (20) installed in the autonomous vehicle (1). Furthermore, the self-driving controlling method has a step of transmitting the acquired sensed data to a remote control device (50) that monitors the autonomous vehicle (1) via a network (2). In addition, the self-driving controlling method has a step of transmitting the sensed data to the remote control device (50) by a communication system selected from a plurality of communication systems in accordance with a predetermined condition.

This can optimize the communication system in accordance with the condition.

[Item 1-10]

A self-driving control program allows a computer to execute processing of acquiring sensed data indicating a situation around an autonomous vehicle (1) from a sensing device (20) installed in the autonomous vehicle (1). Furthermore, the self-driving control program allows the computer to execute processing of transmitting the acquired sensed data to a remote control device (50) that monitors the autonomous vehicle (1) via a network (2). In addition, the self-driving control program allows the computer to execute processing of transmitting sensed data whose data amount is changed in accordance with a predetermined condition to the remote control device (50).

This can optimize the amount of data to be transmitted to remote control device (50) in accordance with the condition.

[Item 1-11]

A self-driving control program allows a computer to execute processing of acquiring sensed data indicating a situation around an autonomous vehicle (1) from a sensing device (20) installed in the autonomous vehicle (1). Furthermore, the self-driving control program allows the computer to execute processing of transmitting the acquired sensed data to a remote control device (50) that monitors the autonomous vehicle (1) via a network (2). In addition, the self-driving control program allows the computer to execute processing of transmitting sensed data to the remote control device (50) by a communication system selected from a plurality of communication systems in accordance with a predetermined condition.

This can optimize the communication system in accordance with condition.

[Item 1-12]

An autonomous vehicle (1) includes a sensed data input section (132), and a communication section (131). The sensed data input section (132) acquires sensed data indicating a situation around the autonomous vehicle (1) from a sensing device (20) installed in the autonomous vehicle (1). The communication section (131) transmits the sensed data acquired by the sensed data input section (132) to a remote control device (50) that monitors the autonomous vehicle (1) via a network (2). Furthermore, the communication section (131) transmits sensed data whose data amount is changed in accordance with a predetermined condition to the remote control device (50).

This can optimize the amount of data to be transmitted to the remote control device (50) in accordance with the condition.

[Item 1-13]

An autonomous vehicle (1) includes a sensed data input section (132), and a communication section (131). The sensed data input section (132) acquires sensed data indicating a situation around the autonomous vehicle (1) from a sensing device (20) installed in the autonomous vehicle (1). The communication section (131) transmits the sensed data acquired by sensed data input section (132) to a remote control device (50) that monitors the autonomous vehicle (1) via a network (2). Furthermore, the communication section (131) transmits the sensed data to the remote control device (50) by a communication system selected from a plurality of communication systems in accordance with a predetermined condition.

This can optimize the communication system in accordance with conditions.

[Item 2-1]

A remote control device (50) includes a communication section (531), and a display (54). The communication section (531) acquires sensed data from an autonomous vehicle (1) via a network (2). The sensed data indicates a situation of the autonomous vehicle (1) and a surrounding of the autonomous vehicle (1). The display (54) displays a picture of a surrounding of the autonomous vehicle (1), which is generated based on the acquired sensed data. Furthermore, the display (54) displays a range object in the picture, in which the range object shows a safety range or a risk range around the autonomous vehicle (1). The range object dynamically changes based on a communication delay between the autonomous vehicle (1) and the remote control device (50), or a risk degree of the autonomous vehicle (1).

This can improve accuracy of judgment by a monitor who carries out remote monitoring using the remote control device (50).

[Item 2-2]

In remote control device (50) described in item 2-1, when the range object shows a safety range, as the communication delay becomes larger, the size of the range object may be reduced. Furthermore, when the range object shows a risk range, as the communication delay becomes larger, the size of the range object may be enlarged.

Thus, a safety range or a risk range excluding influence of the communication delay can be presented to a monitor.

[Item 2-3]

In the remote control device (50) described in item 2-1, when the range object shows the safety range, as the risk degree is higher, the size of the range object may be reduced. Furthermore, when the range object shows the risk range, as the risk degree is higher, the size of the range object may be enlarged.

Thus, the safety range or the risk range, which is optimized in accordance with the risk degree, can be presented to the monitor.

[Item 2-4]

The remote control device (50) described in any one of items 2-1 to 2-3 may further include an operation signal input section (532) that accepts an operation signal based on an operation by the monitor who monitors the autonomous vehicle (1) displayed on the display (54). Furthermore, after the autonomous vehicle (1) stops because it cannot carry out autonomous traveling, when the operation signal input section (532) accepts the operation signal based on a drive restarting operation by the monitor, the communication section (531) may transmit a signal instructing to restart driving to the autonomous vehicle (1) via the network (2). In addition, the display (54) may display whether or not an obstacle is present within a range of the range object, as criteria to restart driving.

This can improve accuracy of judgment to restart driving by the monitor.

[Item 2-5]

A remote control method includes a step of acquiring sensed data indicating a situation of an autonomous vehicle (1) and a surrounding of the autonomous vehicle (1) from the autonomous vehicle (1) via a network (2). Furthermore, the remote control method includes a step of displaying a picture of the surrounding of the autonomous vehicle (1), which is generated based on the acquired sensed data. In the displaying step, a range object showing a safety range or a risk range in the surrounding of autonomous vehicle (1) is displayed in the picture. The range object dynamically changes based on a communication delay between the autonomous vehicle (1) and a remote control device (50), or a risk degree of the autonomous vehicle (1).

This can improve accuracy of judgment by a monitor who carries out remote monitoring using the remote control device (50).

[Item 2-6]

A remote control program allows a computer to execute processing for acquiring sensed data indicating a situation of an autonomous vehicle (1) and a surrounding of the autonomous vehicle (1) from the autonomous vehicle (1) via a network (2). Furthermore, the remote control program allows the computer to execute processing of displaying a picture of the surrounding of autonomous vehicle (1), generated based on the acquired sensed data. In the displaying processing, a range object showing a safety range or a risk range in the surrounding of autonomous vehicle (1) is displayed in the picture. The range object dynamically changes based on a communication delay between the autonomous vehicle (1) and a remote control device (50), or a risk degree of the autonomous vehicle (1).

This can improve accuracy of judgment by a monitor who carries out remote monitoring using the remote control device (50).

[Item 3-1]

A remote control device (50) includes a communication section (531), and a display (54). The communication section (531) acquires sensed data indicating a situation of an autonomous vehicle (1) and a surrounding of the autonomous vehicle (1) from the autonomous vehicle (1) via a network (2). The display (54) displays a picture of the surrounding of the autonomous vehicle (1), which is generated based on the acquired sensed data. Furthermore, the display (54) displays, in the picture, the autonomous vehicle (1) in which a communication delay between the autonomous vehicle (1) and the remote control device (50) is corrected, and the autonomous vehicle (1) in which the communication delay is not corrected.

This can improve accuracy of judgment by a monitor who carries out remote monitoring using the remote control device (50).

[Item 3-2]

In the remote control device (50) described in item 3-1, the communication section (531) may acquire picture data as the sensed data indicating a surrounding situation of the autonomous vehicle (1) from the autonomous vehicle (1) via the network (2). Furthermore, the remote control device (50) may further include a picture analyzer (513) and a picture generator (511). The picture analyzer (513) detects a moving object from an inside of the picture data, detects a movement vector of the moving object, and estimates a moving speed of the moving object. The picture generator (511) generates a picture including the moving object whose communication delay is corrected and the moving object whose communication delay is not corrected in the picture based on the communication delay between the autonomous vehicle (1) and the remote control device (50) and the moving speed of the moving object estimated by the picture analyzer (513).

This can further improve accuracy of judgment of the monitor.

[Item 3-3]

In the remote control device (50) described in any one of items 3-1 or 3-2, the display (54) may display a range object showing a safety range or a risk range of the surrounding of the autonomous vehicle (1) in which the communication delay is corrected, in the picture.

This can further improve accuracy of judgment of the monitor.

[Item 3-4]

A remote control method includes a step of acquiring sensed data indicating a situation of an autonomous vehicle (1) and a surrounding of the autonomous vehicle (1) from the autonomous vehicle (1) via a network (2). Furthermore, the remote control method includes a step of displaying a picture of the surrounding of the autonomous vehicle (1) generated based on the acquired sensed data. In the displaying step, the autonomous vehicle (1) in which a communication delay between the autonomous vehicle (1) and a remote control device (50) is corrected and the autonomous vehicle (1) in which the communication delay is not corrected, are displayed in the picture.

This can improve accuracy of judgment by a monitor who carries out remote monitoring using the remote control device (50).

[Item 3-5]

A remote control program allows a computer to execute processing for acquiring sensed data indicating a situation of an autonomous vehicle (1) and a surrounding of the autonomous vehicle (1) from the autonomous vehicle (1) via a network (2). Furthermore, the remote control program allows the computer to execute processing of displaying a picture of the surrounding of autonomous vehicle (1), generated based on the acquired sensed data. In the displaying processing, the autonomous vehicle (1) in which a communication delay between the autonomous vehicle (1) and a remote control device (50) is corrected and the autonomous vehicle (1) in which the communication delay is not corrected, are displayed in the picture.

This can improve accuracy of judgment by a monitor who carries out remote monitoring using the remote control device (50).

[Item 4-1]

A remote control device (50) includes a communication section (531), a display (54), and an operation signal input section (533). The communication section (531) acquires sensed data indicating a surrounding situation of an autonomous vehicle (1) from the autonomous vehicle (1) via a network (2). The display (54) displays a picture of the surrounding of autonomous vehicle (1), which is generated based on the acquired sensed data. The operation signal input section (533) accepts an operation signal based on the operation by a monitor who monitors the autonomous vehicle (1) displayed on the display (54). After the autonomous vehicle (1) stops because it cannot carry out autonomous traveling, when the operation signal input section (533) accepts the operation signal based on a drive restarting operation by the monitor, the communication section (531) transmits a signal instructing to restart driving to the autonomous vehicle (1) via the network (2).

This makes it possible to quickly restart driving after an emergency stop of the autonomous vehicle (1) while safety is ensured.

[Item 4-2]

When the operation signal input section (533) of the remote control device (50) described in item 4-1 accepts an operation signal based on an operation by the monitor and instructing a traveling route of starting to move at a time of restarting driving of the autonomous vehicle (1), the communication section (531) may transmit a signal instructing the traveling route to the autonomous vehicle (1).

Thus, even when it is difficult to autonomously determine the traveling route at the time of restarting driving after the autonomous vehicle (1) makes an emergency stop, quick restarting driving is possible.

[Item 4-3]

In the remote control device (50) described in item 4-2, the display (54) may be a touch panel display. Furthermore, the communication section (531) may transmit the signal instructing the traveling route generated based on a trajectory which the monitor inputs into the touch panel display.

This can improve the operating property of the monitor.

[Item 4-4]

In the remote control device (50) described in item 4-2 or 4-3, the display (54) may include and display the traveling route of starting to move at the time of restarting driving, which is generated by the autonomous vehicle (1) included in a signal received from the autonomous vehicle (1) via the network (2) into a picture of the surrounding of autonomous vehicle (1).

Thus, the monitor can visually recognize the traveling route of starting to move at the time of restarting driving, which autonomously generated by the autonomous vehicle (1).

[Item 4-5]

In the remote control device (50) described in item 4-4, when the operation signal input section (533) accepts an operation signal based on an operation by the monitor and permitting the traveling route displayed on the display (54), the communication section (531) may transmit a signal for permitting the traveling route to the autonomous vehicle (1).

Thus, providing a step of permitting the traveling route generated by the autonomous vehicle (1) by the monitor allows the safety at the time of restarting driving to be improved.

[Item 4-6]

When the operation signal input section (533) of the remote control device (50) described in any one of items 4-1 to 4-5 accepts an operation for requesting to improve quality of the sensed data by the monitor, the communication section (531) may transmit a signal that instructs to improve quality of the sensed data to the autonomous vehicle (1) via the network (2).

This can improve convenience of the monitor.

[Item 4-7]

A remote control method includes a step of acquiring sensed data indicating a surrounding situation of an autonomous vehicle (1) from the autonomous vehicle (1) via a network (2). Furthermore, the remote control method includes a step of displaying a picture of the surrounding of autonomous vehicle (1), in which the picture is generated based on the acquired sensed data. In addition, the remote control method includes a step of accepting an operation signal based on an operation by a monitor who monitors the displayed autonomous vehicle (1). In addition, the method includes a step of transmitting a signal instructing to restart driving to the autonomous vehicle (1) via the network (2) when an operation signal based on a drive restarting operation by the monitor is accepted after the autonomous vehicle (1) stops because it cannot carry out autonomous traveling.

This makes it possible to quickly restart driving after an emergency stop of the autonomous vehicle (1) while safety is ensured.

[Item 4-8]

A remote control program allows a computer to execute processing for acquiring sensed data indicating a surrounding situation of an autonomous vehicle (1) from the autonomous vehicle (1) via a network (2). Furthermore, the remote control program allows the computer to execute processing of displaying a picture of the surrounding of autonomous vehicle (1), which is generated based on the acquired sensed data. In addition, the remote control program allows the computer to execute processing of accepting an operation signal based on an operation by a monitor who monitors the displayed autonomous vehicle (1). Furthermore, when an operation signal based on a drive restarting operation by the monitor is accepted after autonomous vehicle (1) stops because it cannot carry out autonomous traveling, the remote control program allows the computer to execute processing of transmitting a signal instructing to restart driving to the autonomous vehicle (1) via the network (2).

This makes it possible to quickly restart driving after an emergency stop of the autonomous vehicle (1) while safety is ensured.

[Item 4-9]

An autonomous vehicle control device (10) includes a sensed data input section (132), an autonomous driving controller (111), and a communication section (131). The sensed data input section (132) acquires sensed data indicating a surrounding situation of an autonomous vehicle (1) from a sensing device (20) installed in the autonomous vehicle (1). The autonomous driving controller (111) autonomously controls driving of the autonomous vehicle (1) based on the acquired sensed data. The communication section (131) transmits the sensed data acquired by the sensed data input section (132) to a remote control device (50) that monitors the autonomous vehicle (1) via a network (2), and receives an instruction signal from the remote control device (50) via the network (2). After the autonomous driving controller (111) stops the autonomous vehicle (1) because autonomous traveling cannot be carried out, when the communication section (131) receives a signal instructing a traveling route of start of movement at a time of restarting driving from the remote control device (50), and when the instructed traveling route is a route that cannot be traveled, the autonomous driving controller (111) transmits a signal that rejects the traveling route to the remote control device (50).

This makes it possible to ensure safety when the autonomous vehicle (1) restarts driving.

[Item 4-10]

In the autonomous vehicle control device (10) described in item 4-9, the autonomous driving controller (111) may generate the other traveling route that can be traveled in a case where the instructed traveling route is a route that cannot be traveled, and transmit the generated traveling route to the remote control device (50).

Thus, the safety at the time of restarting driving can be improved by transmitting the new traveling route from the autonomous vehicle control device (10) to the remote control device (50) and requesting the confirmation of the monitor.

[Item 4-11]

A self-driving controlling method has a step of acquiring sensed data indicating a surrounding situation of an autonomous vehicle (1) from a sensing device (20) installed in the autonomous vehicle (1). Furthermore, the self-driving controlling method has a step of autonomously controlling a drive of the autonomous vehicle (1) based on the acquired sensed data. In addition, the self-driving controlling method has a step of transmitting the acquired sensed data to a remote control device (50) that monitors the autonomous vehicle (1) via a network (2). In addition, the self-driving controlling method has a step of receiving an instruction signal from the remote control device (50) via the network (2). In addition, the self-driving controlling method has a step of transmitting a signal for rejecting a traveling route of starting to move at a time of restarting driving to the remote control device (50) after autonomous vehicle (1) stops because it cannot carry out autonomous traveling, when a signal for instructing the traveling route is received from the remote control device (50), and the instructed traveling route is a route that cannot be traveled.

This makes it possible to ensure safety when the autonomous vehicle (1) restarts driving.

[Item 4-12]

A self-driving control program allows a computer to execute processing of acquiring sensed data indicating a surrounding situation of autonomous vehicle (1) from sensing device (20) installed in the autonomous vehicle (1). Furthermore, the self-driving control program allows the computer to execute autonomously control of a drive of the autonomous vehicle (1) based on the acquired sensed data. In addition, the self-driving control program allows the computer to execute processing of transmitting the acquired sensed data via a network (2) to a remote control device (50) that monitors the autonomous vehicle (1). In addition, the self-driving control program allows the computer to execute processing of receiving an instruction signal from the remote control device (50) via the network (2). In addition, the self-driving control program allows the computer to execute processing of transmitting a signal for rejecting a traveling route of starting to move at a time of restarting driving to the remote control device (50) after the autonomous vehicle (1) stops because it cannot carry out autonomous traveling, when a signal for instructing the traveling route is received from remote control device (50), and the instructed traveling route is a route that cannot be traveled.

This makes it possible to ensure safety when the autonomous vehicle (1) restarts driving.

[Item 4-13]

An autonomous vehicle (1) includes a sensed data input section (132), an autonomous driving controller (111), and a communication section (131). The sensed data input section (132) acquires sensed data indicating a surrounding situation of the autonomous vehicle (1) from a sensing device (20) installed in the autonomous vehicle (1). The autonomous driving controller (111) autonomously controls of a drive of the autonomous vehicle (1) based on the acquired sensed data. The communication section (131) transmits the sensed data acquired by the sensed data input section (132) to a remote control device (50) that monitors the autonomous vehicle (1) via a network (2), and receives an instruction signal from the remote control device (50) via the network (2). After the autonomous driving controller (111) stops the autonomous vehicle (1) because autonomous traveling cannot be carried out, when the communication section (131) receives a signal instructing a traveling route of start to move at a time of restarting driving from the remote control device (50), and when the instructed traveling route is a route that cannot be traveled, autonomous driving controller (111) transmits a signal that rejects the traveling route to the remote control device (50).

This makes it possible to ensure safety when the autonomous vehicle (1) restarts driving.

[Item 5-1]

A remote monitoring system (1, 50) includes a vehicle (1) and a remote monitoring device (50). The vehicle (1) includes an imaging circuit (21) configured to shoot a surrounding in at least a traveling direction of the vehicle (1), and a wireless communication circuit (131a) configured to transmit an image shot by the imaging circuit (21). The remote monitoring device (50) includes a communication circuit (531a) configured to receive a first image from the wireless communication circuit (131a) via a network (2), and an output circuit (532) configured to output a second image. In the remote monitoring device (50), when a communication delay from the vehicle (1) to the remote monitoring device (50) via the network (2) is first delay time, the output circuit (532) cuts out a first range (COa) from a first frame of the first image and outputs the first range as a second image. In the remote monitoring device (50), when the communication delay from the vehicle (1) to the remote monitoring device (50) via the network (2) is second delay time that is longer than the first delay time, the output circuit (532) cuts out a second range (Cob) that is narrower than the first range (COa) from a second frame of the first image and outputs the second range as the second image.

Thus, it is possible to generate a second image in which an influence on the communication delay is compensated.

[Item 5-2]

In the remote monitoring system (1, 50) described in item 5-1, the second frame of the first image may be identical to the first frame of the first image.

Thus, even when the communication delay becomes larger, the second image can be generated at the defined display timing.

[Item 5-3]

In the remote monitoring system (1, 50) described in item 5-1 or item 5-2, the remote monitoring device (50) may further include a display (54) connected to the output circuit (532), and the display (54) may output the second image.

Thus, a remote monitor/manipulator can see the second image in real time in which the influence of the communication delay is compensated.

[Item 5-4]

In the remote monitoring system (1, 50) described in any one of items 5-1 to item 5-3, the first frame of the first image and the second frame of the first image, received by the communication circuit (531a) of the remote monitoring device (50), may be quadrangular.

Thus, the image can be transmitted from the autonomous vehicle (1) to the remote control device (50) by a general picture format.

[Item 5-5]

In the remote monitoring system (1, 50) described in any one of items 5-1 to item 5-4, a shape of the first range (COa) in the first frame of the first image may be similar to a shape of the second range (Cob) in the second frame of the first image.

Thus, it is possible to generate the second image at a time when the autonomous vehicle (1) travels straight by a simple and easy process.

[Item 5-6]

In the remote monitoring system (1, 50) described in any one of items 5-1 to 5-5, the vehicle (1) may further include a speed detection circuit (24) that detects a traveling speed of the vehicle (1). Furthermore, the wireless communication circuit (131a) may be configured to transmit the traveling speed. Furthermore, the communication circuit (531a) of the remote monitoring device (50) may be configured to receive the traveling speed from the wireless communication circuit (131a) via the network (2). In addition, in the remote monitoring device (50), when the communication delay from the vehicle (1) to the remote monitoring device (50) via the network (2) is third delay time, and when the traveling speed received by the communication circuit (531a) is a first speed, the output circuit (532) may cut out a third range (COa) from a third frame of the first image and output the third range as the second image. In addition, in the remote monitoring device (50), when the communication delay from the vehicle (1) to the remote monitoring device (50) via the network (2) is the third delay time, and when the traveling speed received by the communication circuit (531a) is a second speed that is faster than the first speed, the output circuit (532) may cut out a fourth range (Cob) that is narrower than the third range (COa) from a fourth frame of the first image, and the output circuit (532) may output the fourth range as the second image. In addition, the third delay time may be larger than zero. In addition, the third speed may include zero.

Thus, it is possible to generate the second image in which an influence of change in speed is compensated.

[Item 5-7]

In the remote monitoring system (1, 50) described in item 5-6, a shape of the third range (COa) of the third frame of the first image may be similar to a shape of the fourth range (Cob) of the fourth frame of the first image.

Thus, it is possible to generate the second image at the time when the autonomous vehicle (1) travels straight by a simple and easy process.

[Item 5-8]

In the remote monitoring system (1, 50) described in item 5-6 or 5-7, the vehicle (1) may further include a steering angle detection circuit (26) that detects a steering angle of a steered wheel. Furthermore, the wireless communication circuit (131a) may be configured to transmit the steering angle. In addition, the communication circuit (531a) of the remote monitoring device (50) may be configured to receive the steering angle from the wireless communication circuit (131a) via the network (2). In addition, in the remote monitoring device (50), when the communication delay from the vehicle (1) to the remote monitoring device (50) via the network (2) is the third delay time, the traveling speed received by the communication circuit (531a) is a third speed, and the steering angle received by the communication circuit (531a) is a first steering angle, the output circuit (532) may cut out a fifth range (Cob) from a fifth frame of the first image and output the fifth range as the second image. In addition, in the remote monitoring device (50), the communication delay from the vehicle (1) to the remote monitoring device (50) via the network (2) is the third delay time, the traveling speed received by the communication circuit (531a) is the third speed, and the steering angle received by the communication circuit (531a) is a second steering angle, the output circuit (532) may cut out a sixth range (COc) from a sixth frame of the first image and output the sixth range as the second image. The second steering angle is different from the first steering angle. The sixth range (COc) is different from the fifth range (Cob). Furthermore, the third delay time may be larger than zero. Furthermore, the third speed may be larger than zero.

Thus, it is possible to generate the second image in which an influence of change in steering angle is compensated.

[Item 5-9]

In the remote monitoring system (1, 50) described in item 5-8, the steering angle of the steered wheel (31a, 31b) detected by the steering angle detection circuit (26) may be expressed by a first direction and an angle in the first direction with respect to a straight direction of the vehicle (1), or a second direction opposite to the first direction and an angle in the second direction with respect to the straight direction of the vehicle (1). Note here that the first direction may be rightward. In addition, the first direction may be leftward.

Thus, the steering angles of the steered wheel (31a, 31b) can be transmitted in the form of left-right symmetrical numerical data.

[Item 5-10]

In the remote monitoring device (50) of the remote monitoring system (1, 50) described in item 5-9, when the communication delay from the vehicle (1) to the remote monitoring device (50) via the network (2) is the third delay time, the traveling speed received by the communication circuit (531a) is the third speed, and the steering angle received the communication circuit (531a) shows the straight direction, the output circuit (532) may cut out a seventh range (Cob) and output the seventh range as the second image. In this case, the seventh range (Cob) is cut out from a seventh frame of the first image. Furthermore, when the communication delay from the vehicle (1) to the remote monitoring device (50) via the network (2) is the third delay time, the traveling speed received by the communication circuit (531a) is the third speed, and the steering angle received by the communication circuit (531a) is a first angle (α1), the output circuit (532) may cut out an eighth range (COc, COf) from an eighth frame of the first image, and output circuit (532) may output the eighth range as the second image. In this case, the steering angle is the first angle (α1) in the first direction with respect to the straight direction, and the eighth range (COc, COf) is displaced in the first direction (D1) with respect to the seventh range (COb). In addition, the communication delay from the vehicle (1) to the remote monitoring device (50) via the network (2) is the third delay time, the traveling speed received by the communication circuit (531a) is the third speed, and the steering angle received by the communication circuit (531a) is a second angle (α2), the output circuit (532) may cut out a ninth range (Cod, Cog) from a ninth frame of the first image, and output circuit (532) may output the ninth range as the second image. In this case, the steering angle is the second angle (α2) in the second direction (D2) with respect to the straight direction, the ninth range (Cod, COf) is displaced in the second direction (D2) that is different from the first direction (D1) with respect to the sixth range (COc). In addition, the first angle may be a positive value. In addition, the second angle may be a positive value.

Thus, it is possible to generate the second image in which an influence of change in steering angle is compensated.

[Item 5-11]

In the remote monitoring system (1, 50) described in item 5-10, a width perpendicular to the first direction (D1) at an end portion (E1) of the eighth range (COc, COf) in the first direction (D1) may be wider than a width perpendicular to the first direction (D1) at an end portion (E2) of the eighth range (COc, COf) in a direction opposite to the first direction (D1). Furthermore, a width perpendicular to the second direction (D2) at an end portion (E2) of the ninth range (Cod, COg) in the second direction (D2) may be wider than a width perpendicular to the second direction (D2) at an end portion (E1) of the ninth range (Cod, Cog) in a direction opposite to the second direction (D2).

Thus, it is possible to generate the second image in which an influence of change in steering angle is compensated.

[Item 5-12]

In the remote monitoring system (1, 50) described in item 5-10 or 5-11, the second direction (D2) may be opposite to the first direction (D1).

Thus, the cutout range can be moved in a left-right symmetric manner.

[Item 5-13]

In the remote monitoring system (1, 50) described in any one of items 5-1 to 5-12, the output circuit (532) of the remote monitoring device (50) may output the second image with an object showing a predetermined region superimposed in the frame of the second image. Furthermore, the predetermined region may be a risk region.

This makes it possible to alert a remote monitor/manipulator.

[Item 5-14]

A remote monitoring device (50) includes a communication circuit (531a) configured to receiving a first image via a network (2), and an output circuit (532) configured to outputting a second image. The communication circuit (531a) is configured to receive the first image from a wireless communication circuit (131a) of an outside vehicle (1) via the network (2). The vehicle (1) further includes an imaging circuit (21) configured to shoot a surrounding in at least a traveling direction of the vehicle (1), and the wireless communication circuit (131a) of the vehicle (1) is configured to transmit an image shot by the imaging circuit (21). When a communication delay from the vehicle (1) to the remote monitoring device (50) via the network (2) is first delay time, the output circuit (532) cuts out a first range (COa) from a first frame of the first image and outputs the first range as the second image. When the communication delay from the vehicle (1) to the remote monitoring device (50) via the network (2) is second delay time that is longer than the first delay time, output circuit (532) cuts out a second range (Cob) that is narrower than the first range (COa) from a second frame of the first image, and outputs the second range (Cob) as the second image.

Thus, it is possible to generate the second image in which an influence on the communication delay is compensated.

[Item 5-15]

In the remote monitoring device (50) described in item 5-14, the second frame of the first image may be the same as the first frame of the first image.

Thus, even when the communication delay becomes larger, the second image can be generated at the defined timing.

[Item 5-16]

The remote monitoring device (50) described in item 5-14 or 5-15 may further include a display (54) connected to the output circuit (532), and the display (54) may output the second image.

Thus, a remote monitor/manipulator can see a second image in real time in which the influence of the communication delay is compensated.

[Item 5-17]

In the remote monitoring device (50) described in any one of items 5-14 to 5-16, the first frame of the first image and the second frame of the first image may be quadrangular.

Thus, the image can be transmitted from the autonomous vehicle (1) to the remote control device (50) by a general image format.

[Item 5-18]

In the remote monitoring device (50) described in any one of items 5-14 to 5-17, a shape of the first range (COa) in the first frame of the first image may be similar to a shape of the second range (COb) in the second frame of the first image.

Thus, it is possible to generate the second image at the time when the autonomous vehicle (1) travels straight by a simple and easy process.

[Item 5-19]

In the remote monitoring device (50) described in any one of items 5-14 to 5-18, the vehicle (1) may further include a speed detection circuit (24) that detects a traveling speed of the vehicle (1). Furthermore, the wireless communication circuit (131a) may be configured to transmit the traveling speed. Furthermore, the communication circuit (531a) may be configured to receive the traveling speed from the wireless communication circuit (131a) via the network (2). In addition, when the communication delay from the vehicle (1) to the remote monitoring device (50) via the network (2) is third delay time, and when the traveling speed received by the communication circuit (531a) is a first speed, the output circuit (532) may cut out a third range (COa) from a third frame of the first image and output the third range as the second image. In addition, when the communication delay from the vehicle (1) to the remote monitoring device (50) via the network (2) is the third delay time, and when the traveling speed received by the communication circuit (531a) is a second speed that is faster than the first speed, the output circuit (532) may cut out a fourth range (COb) that is narrower than third range (COa) from a fourth frame of the first image, and may output the fourth range as the second image. In addition, the third delay time may be larger than zero. In addition, the third speed may include zero.

Thus, it is possible to generate the second image in which an influence of change in speed is compensated.

[Item 5-20]

In the remote monitoring device (50) described in item 5-19, a shape of the third range (COa) of the third frame of the first image may be similar to a shape of the fourth range (Cob) of the fourth frame of the first image.

Thus, it is possible to generate the second image at the time when the autonomous vehicle (1) travels straight by a simple and easy process.

[Item 5-21]

In the remote monitoring device (50) described in item 5-19 or 5-20, the vehicle (1) may further include a steering angle detection circuit (26) that detects a steering angle of a steered wheel. Furthermore, the wireless communication circuit (131a) may be configured to transmit the steering angle. In addition, the communication circuit (531a) may be configured to receive the steering angle from the wireless communication circuit (131a) via the network (2). In addition, when the communication delay from the vehicle (1) to the remote monitoring device (50) via the network (2) is the third delay time, the traveling speed received by the communication circuit (531a) is a third speed, and the steering angle received by the communication circuit (531a) is a first steering angle, the output circuit (532) may cut out a fifth range (Cob) from a fifth frame of the first image and output the fifth range as the second image. In addition, when the communication delay from the vehicle (1) to the remote monitoring device (50) via the network (2) is the third delay time, the traveling speed received by the communication circuit (531a) is the third speed, and the steering angle received by the communication circuit (531a) is second steering angle that is different from the first steering angle, the output circuit (532) may cut out a sixth range (COc) that is different from the fifth range (Cob) from a sixth frame of the first image and output the sixth range as the second image. In addition, the third delay time may be larger than zero. In addition, the third speed may be larger than zero.

Thus, it is possible to generate the second image in which an influence of change in steering angle is compensated.

[Item 5-22]

In the remote monitoring device (50) described in item 5-21, the steering angle of the steered wheel detected by the steering angle detection circuit (26) may be expressed by a first direction and an angle in the first direction with respect to a straight direction of the vehicle (1), or a second direction opposite to the first direction and an angle in the second direction with respect to the straight direction of the vehicle (1). In addition, the first direction may be rightward. In addition, the first direction may be leftward.

Thus, the steering angle of the steered wheel (31a, 31b) can be transmitted in the form of left-right symmetrical numerical data.

[Item 5-23]

In the remote monitoring device (50) described in item 5-22, when the communication delay from the vehicle (1) to the remote monitoring device (50) via the network (2) is the third delay time, the traveling speed received by the communication circuit (531a) is the third speed, and when the steering angle received communication circuit (531a) shows the straight direction, the output circuit (532) may cut out a seventh range (COb) from a seventh frame of the first image, and output the seventh range as the second image. Furthermore, when the communication delay from the vehicle (1) to the remote monitoring device (50) via the network (2) is the third delay time, the traveling speed received by the communication circuit (531a) is the third speed, and the steering angle received by the communication circuit (531a) is a first angle (α1), the output circuit (532) may cut out an eighth range (COc, COf) from an eighth frame of the first image, and may output the eighth range as the second image. In this case, the steering angle is the first angle (α1) in the first direction with respect to the straight direction, and the eighth range (COc, COf) is displaced in the first direction (D1) with respect to the seventh range (COb). In addition, the communication delay from the vehicle (1) to the remote monitoring device (50) via the network (2) is the third delay time, the traveling speed received by the communication circuit (531a) is the third speed, and the steering angle received by the communication circuit (531a) is a second angle (α2), the output circuit (532) may cut out a ninth range (Cod, COf) from a ninth frame of the first image, and output the ninth range as the second image. In this case, the steering angle is the second angle (α2) in the second direction (D2) with respect to the straight direction, the ninth range (Cod, COf) is displaced in the second direction (D2) that is different from the first direction (D1) with respect to the sixth range (COc). In addition, the first angle may be a positive value. In addition, the second angle may be a positive value.

Thus, it is possible to generate the second image in which an influence of change in steering angle is compensated.

[Item 5-24]

In the remote monitoring device (50) described in item 5-23, a width perpendicular to the first direction (D1) at an end portion (E1) of the eighth range (COc, COf) in the first direction (D1) may be wider than a width perpendicular to the first direction (D1) at an end portion (E2) of the eighth range (COc, COf) in a direction opposite to the first direction (D1). Furthermore, a width perpendicular to the second direction (D2) at an end portion (E2) of the ninth range (Cod, COg) in the second direction (D2) may be wider than a width perpendicular to the second direction (D2) at an end portion (E1) of the ninth range (Cod, Cog) in a direction opposite to the second direction (D2).

Thus, it is possible to generate the second image in which an influence of change in steering angle is compensated.

[Item 5-25]

In the remote monitoring device (50) described in item 5-23 or 5-24, the second direction (D2) may be opposite to the first direction (D1).

Thus, the range cutout can be moved in a left-right symmetric manner.

[Item 5-26]

In the remote monitoring device (50) described in any one of items 5-14 to 5-25, the output circuit (532) may output the second image with an object showing a predetermined region superimposed in the frame of the second image. Furthermore, the predetermined region may be a risk region.

This makes it possible to alert a remote monitor/manipulator.

The present disclosure is useful as a remote monitoring system and a remote monitoring device.

What is claimed is:

1. A remote monitoring system comprising:
a vehicle including:
an imaging circuit configured to shoot a surrounding in at least a traveling direction of the vehicle; and
a wireless communication circuit configured to transmit an image shot by the imaging circuit; and
a remote monitoring device including:
a communication circuit configured to receive a first image from the wireless communication circuit via a network; and
an output circuit configured to output a second image,
wherein, in the remote monitoring device, in a case where a communication delay from the vehicle to the remote monitoring device via the network is first delay time, the output circuit cuts out a first range from a first frame of the first image and outputs the first range as the second image, and
in the remote monitoring device, in a case where the communication delay from the vehicle to the remote monitoring device via the network is second delay time that is longer than the first delay time, the output circuit cuts out a second range that is narrower than the first range from a second frame of the first image and outputs the second range as the second image.

2. The remote monitoring system according to claim 1,
wherein the second frame of the first image is identical to the first frame of the first image.

3. The remote monitoring system according to claim 1,
wherein the remote monitoring device further includes a display connected to the output circuit, and
the display outputs the second image.

4. The remote monitoring system according to claim 1,
wherein the first frame of the first image and the second frame of the first image that are to be received by the communication circuit of the remote monitoring device are quadrangular.

5. The remote monitoring system according to claim 1,
wherein a shape of the first range in the first frame of the first image and a shape of the second range in the second frame of the first image are similar to each other.

6. The remote monitoring system according to claim 1,
wherein the vehicle further includes a speed detection circuit that detects a traveling speed of the vehicle,
the wireless communication circuit is configured to transmit the traveling speed,
the communication circuit of the remote monitoring device is configured to receive the traveling speed from the wireless communication circuit via the network,
in the remote monitoring device, in a case where the communication delay from the vehicle to the remote monitoring device via the network is third delay time, and the traveling speed received by the communication circuit is a first speed, the output circuit cuts out a third range from a third frame of the first image and outputs the third range as the second image, and
in the remote monitoring device, in a case where the communication delay from the vehicle to the remote monitoring device via the network is the third delay time, and the traveling speed received by the communication circuit is a second speed that is faster than the first speed, the output circuit cuts out a fourth range that is narrower than the third range from a fourth frame of the first image and outputs the fourth range as the second image.

7. The remote monitoring system according to claim 6,
wherein a shape of the third range in the third frame of the first image and a shape of the fourth range in the fourth frame of the first image are similar to each other.

8. The remote monitoring system according to claim 6,
wherein the vehicle further includes a steering angle detection circuit that detects a steering angle of a steered wheel,
the wireless communication circuit is configured to transmit the steering angle,
the communication circuit of the remote monitoring device is configured to receive the steering angle from the wireless communication circuit via the network,
in the remote monitoring device, in a case where the communication delay from the vehicle to the remote monitoring device via the network is the third delay time, the traveling speed received by the communication circuit is a third speed, and the steering angle received by the communication circuit is a first steering angle, the output circuit cuts out a fifth range from a fifth frame of the first image and outputs the fifth range as the second image, and
in the remote monitoring device, in a case where the communication delay from the vehicle to the remote monitoring device via the network is the third delay time, the traveling speed received by the communication circuit is the third speed, and the steering angle received by the communication circuit is a second steering angle that is different from the first steering angle, the output circuit cuts out a sixth range that is different from the fifth range from a sixth frame of the first image and outputs the sixth range as the second image.

9. The remote monitoring system according to claim 8,
wherein the steering angle of the steered wheel to be detected by the steering angle detection circuit is expressed by a first direction and an angle in the first direction with respect to a straight direction of the vehicle, or a second direction opposite to the first direction and an angle in the second direction with respect to the straight direction of the vehicle.

10. The remote monitoring system according to claim 9,
wherein in the remote monitoring device, in a case where the communication delay from the vehicle to the remote monitoring device via the network is the third delay time, the traveling speed received by the communication circuit is the third speed, and the steering angle received by the communication circuit shows the straight direction, the output circuit cuts out a seventh range from a seventh frame of the first image and outputs the seventh range as the second image,
in the remote monitoring device, in a case where the communication delay from the vehicle to the remote monitoring device via the network is the third delay time, the traveling speed received by the communication circuit is the third speed, and the steering angle received by the communication circuit is a first angle in the first direction with respect to the straight direction, the output circuit cuts out an eighth range from an eight frame of the first image, the eighth range being displaced in the first direction with respect to the seventh range, and outputs the eighth range as the second image, and
in the remote monitoring device, in a case where the communication delay from the vehicle to the remote monitoring device via the network is the third delay time, the traveling speed received by the communication circuit is the third speed, and the steering angle received by the communication circuit is a second angle in the second direction with respect to the straight direction, the output circuit cuts out a ninth range from a ninth frame of the first image, the ninth range being displaced in a second direction that is different from the first direction with respect to the sixth range, and outputs the ninth range as the second image.

11. The remote monitoring system according to claim 10,
wherein a width perpendicular to the first direction at an end portion of the eighth range in the first direction is wider than a width perpendicular to the first direction at an end portion of the eighth range in a direction opposite to the first direction, and
a width perpendicular to the second direction at an end portion of the ninth range in the second direction is wider than a width perpendicular to the second direction at an end portion of the ninth range in a direction opposite to the second direction.

12. The remote monitoring system according to claim 10,
wherein the second direction is opposite to the first direction.

13. The remote monitoring system according to claim 1,
wherein the output circuit of the remote monitoring device outputs the second image with an object showing a predetermined region superimposed in a frame of the second image.

14. A remote monitoring device comprising:
a communication circuit configured to receive a first image via a network; and
an output circuit configured to output a second image,
wherein the communication circuit is configured to receive the first image from a wireless communication circuit provided in an outside vehicle via the network,
the vehicle further includes an imaging circuit configured to shoot a surrounding in at least a traveling direction of the vehicle,
the wireless communication circuit of the vehicle is configured to transmit an image shot by the imaging circuit,
in a case where a communication delay from the vehicle to the remote monitoring device via the network is first delay time, the output circuit cuts out a first range from a first frame of the first image and outputs the first range as the second image, and
in a case where the communication delay from the vehicle to the remote monitoring device via the network is second delay time that is longer than the first delay time, the output circuit cuts out a second range that is narrower than the first range from a second frame of the first image and outputs the second range as the second image.

15. The remote monitoring device according to claim 14,
wherein the second frame of the first image is identical to the first frame of the first image.

16. The remote monitoring device according to claim 14, further comprising a display connected to the output circuit,
wherein the display outputs the second image.

17. The remote monitoring device according to claim 14,
wherein the first frame of the first image and the second frame of the first image are quadrangular.

18. The remote monitoring device according to claim 14,
wherein a shape of the first range in the first frame of the first image and a shape of the second range in the second frame of the first image are similar to each other.

19. The remote monitoring device according to claim 14,
wherein the vehicle further includes a speed detection circuit that detects a traveling speed of the vehicle,
the wireless communication circuit is configured to transmit the traveling speed,
the communication circuit is configured to receive the traveling speed from the wireless communication circuit via the network,
in a case where a communication delay from the vehicle to the remote monitoring device via the network is third delay time, and the traveling speed received by the communication circuit is a first speed, the output circuit cuts out a third range from a third frame of the first image and outputs the third range as the second image, and
in a case where the communication delay from the vehicle to the remote monitoring device via the network is the third delay time, and the traveling speed received by the communication circuit is a second speed that is faster than the first speed, the output circuit cuts out a fourth range that is narrower than the third range from a fourth frame of the first image and outputs the fourth range as the second image.

20. The remote monitoring device according to claim 19,
wherein a shape of the third range in the third frame of the first image and a shape of the fourth range in the fourth frame of the first image are similar to each other.

21. The remote monitoring device according to claim 19, further comprising a steering angle detection circuit that detects a steering angle of a steered wheel,
wherein the wireless communication circuit is configured to transmit the steering angle,
the communication circuit is configured to receive the steering angle from the wireless communication circuit via the network,
in a case where a communication delay from the vehicle to the remote monitoring device via the network is the third delay time, the traveling speed received by the communication circuit is a third speed, and the steering angle received by the communication circuit is a first steering angle, the outputs circuit cuts out a fifth range from a fifth frame of the first image, and output the fifth range as the second image, and
in a case where the communication delay from the vehicle to the remote monitoring device via the network is the third delay time, the traveling speed received by the communication circuit is the third speed, and the steering angle received by the communication circuit is a second steering angle that is different from the first steering angle, the output circuit cuts out a sixth range that is different from the fifth range from a sixth frame of the first image and outputs the sixth range as the second image.

22. The remote monitoring device according to claim 21,
wherein the steering angle of the steered wheel to be detected by the steering angle detection circuit is expressed by a first direction and an angle in the first direction with respect to a straight direction of the vehicle, or a second direction opposite to the first direction and an angle in the second direction with respect to the straight direction of the vehicle.

23. The remote monitoring device according to claim 22,
wherein in a case where a communication delay from the vehicle to the remote monitoring device via the network is the third delay time, the traveling speed received by the communication circuit is a third speed, and the steering angle received by the communication circuit shows the straight direction, the output circuit cuts out a seventh range from a seventh frame of the first image and outputs the seventh range as the second image,
in a case where the communication delay from the vehicle to the remote monitoring device via the network is the third delay time, the traveling speed received by the communication circuit is the third speed, and the steering angle received by the communication circuit is a first angle in the first direction with respect to the straight direction, the output circuit cuts out an eighth range from an eight frame of the first image, the eighth range being displaced in the first direction with respect to the seventh range, and outputs the eighth range as the second image, and
in a case where the communication delay from the vehicle to the remote monitoring device via the network is the third delay time, the traveling speed received by the communication circuit is the third speed, and the steering angle received by the communication circuit is a second angle in the second direction with respect to the straight direction, the output circuit cuts out a ninth range from a ninth frame of the first image, the ninth range being displaced in a second direction that is different from the first direction with respect to the sixth range, and outputs the ninth range as the second image.

24. The remote monitoring device according to claim 23,
wherein a width perpendicular to the first direction at an end portion of the eighth range in the first direction is wider than a width perpendicular to the first direction at an end portion of the eighth range in a direction opposite to the first direction, and
a width perpendicular to the second direction at an end portion of the ninth range in the second direction is wider than a width perpendicular to the second direction at an end portion of the ninth range in a direction opposite to the second direction.

25. The remote monitoring device according to claim 23,
wherein the second direction is opposite to the first direction.

26. The remote monitoring device according to claim 14,
wherein the output circuit outputs the second image with an object showing a predetermined region superimposed in a frame of the second image.
